(19) United States
(12) Patent Application Publication
(10) Pub. No.: US 2024/0295704 A1
(43) Pub. Date: Sep. 5, 2024

(54) Detachable Connectors for Co-Packaged Optics

(71) Applicant: Teramount Ltd., Jerusalem (IL)

(72) Inventors: Abraham Israel, Jerusalem (IL); Hesham Taha, Jerusalem (IL); Shay Yulzary, Hod Hasharon (IL); Idan Mor, Hod Hasharon (IL); Guy Livnat, Jerusalem (IL)

(21) Appl. No.: 18/594,166

(22) Filed: Mar. 4, 2024

Related U.S. Application Data
(60) Provisional application No. 63/491,756, filed on Mar. 23, 2023.
(60) Provisional application No. 63/488,336, filed on Mar. 3, 2023.

(51) Int. Cl. G02B 6/36; G02B 6/38

(52) U.S. Cl. CPC G02B 6/3636; G02B 6/3885

(57) ABSTRACT

Systems, apparatuses, and methods for detachable fiber connector (FC) for optical coupling based on a coarse alignment and fine alignment are described. A photonic plug may be horizontally inserted into a receptacle and coarsely aligned with a photonic integrated circuit (PIC). The photonic plug may be moved vertically in the direction of the PIC. First fine alignment features, of the photonic plug, may engage second fine alignment features, associated with the PIC, aligning the photonic plug and the PIC. Systems, Mechanisms, and methods for retaining and for releasing the detachable connectors are also described.

### CROSS-REFERENCE TO RELATED APPLICATIONS

The present application claims the benefit of and priority to Provisional U.S. Application No. 63/488,336, filed on Mar. 3, 2023, and to Provisional U.S. Application No. 63/491,756, filed on Mar. 23, 2023. The contents of all of the aforementioned applications are incorporated herein by reference in their entirety.

### BACKGROUND

In optical coupling, optical components optically coupled to a photonic integrated circuit (PIC) (e.g., in a silicon photonics (SiPh) chip) are often connected to the PIC via a permanent method of attachment, for example, via bonding (e.g., via adhesive or epoxy). However, direct bonding of the optical components to the PIC may be associated with various disadvantages.

### SUMMARY

The following summary presents a simplified summary of certain features. The summary is not an extensive overview and is not intended to identify key or critical elements.

Systems, apparatuses, and methods are described for a detachable fiber connector (FC) for optical coupling to a chip. The detachable FC may be based on, for example, a rough alignment and fine alignment. The disclosed technology may utilize a lateral (e.g., horizontal) insertion of the FC, a vertical move for FC engagement with the photonic integrated circuit (PIC), and then a retention (e.g., press, hold, engage, etc.) mechanism to secure or release the FC from the chip. By using detachable optical connections, advantages may be achieved such as to easily be assembled/disassembled, replaced, expanded, and/or serviced, as well as maintain a relatively thin form factor and maintain alignment of the connection for integration with chip packages.

These and other features and advantages are described in greater detail below.

### BRIEF DESCRIPTION OF THE FIGURES

FIG. 1 depicts an example photonic integrated circuit (PIC) connected to a package substrate and a main board according to one or more aspects of the present disclosure.

FIG. 2A depicts an example PIC connected to a package substrate.

FIG. 2B depicts a bottom-side optical coupler receptacle attached to the example PIC and package substrate of FIG. 2A according to one or more aspects of the present disclosure.

FIG. 2C depicts an alternate configuration of an example bottom-side optical coupler receptacle according to one or more aspects of the present disclosure.

FIG. 3 depicts a section view of the detachable connector 300 according to one or more aspects of the present disclosure.

FIG. 4 depicts an example uninstalled detachable connector according to one or more aspects of the present disclosure

FIGS. 5A-5B depict different views of an example plug assembly according to one or more aspects of the present disclosure.

FIGS. 6A-6C depict various views of an example receptacle according to one or more aspects of the present disclosure.

FIG. 7 depicts an example detachable connector in a seated configuration according to one or more aspects of the present disclosure.

FIGS. 8A-8E depict example alternative plug assembly retention features according to one or more aspects of the present disclosure.

FIGS. 9A-9G depict example PIC, package substrate, and main board arrangements according to one or more aspects of the present disclosure.

FIG. 10 depicts a top through-view of an example receptacle, an underlying PIC, and package substrate according to one or more aspects of the present disclosure.

FIG. 11 depicts a through-view of an example receptacle, an underlying PIC, and uninstalled plug assembly according to one or more aspects of the present disclosure.

FIG. 12 depicts a top through-view of an example receptacle and underlying PIC and package substrate according to one or more aspects of the present disclosure.

FIG. 13 depicts an example receptacle and uninstalled plug assembly according to one or more aspects of the present disclosure.

FIG. 14A depicts an example exploded plug assembly according to one or more aspects of the present disclosure.

FIG. 14B depicts an example plug cover with an example photonic plug and fine alignment features.

FIGS. 15A-15B, depict example plug assemblies and example receptacles in an example closed and installed state according to one or more aspects of the present disclosure.

FIG. 16 depicts an example plug assembly according to one or more aspects of the present disclosure.

FIG. 17 depicts an example open receptacle without a plug assembly according to one or more aspects of the present disclosure.

FIG. 18 depicts an alternative configuration of detachable connectors according to one or more aspects of the present disclosure.

FIGS. 19A-19C depict various views of an example alternatively configured plug assembly according to one or more aspects of the present disclosure.

FIG. 20 depicts a through-view of an example receptacle and plug assembly according to one or more aspects of the present disclosure.

FIG. 21 depicts rough alignment features between receptacle and plug according to one or more aspects of the present disclosure.

FIG. 22 depicts a plug installed in a receptacle according to one or more aspects of the present disclosure.

FIG. 23A and FIG. 23B depict examples of fine alignment features according to one or more aspects of the present disclosure.

FIG. 24 depicts a bottom view of an example photonic plug having three v-grooves according to one or more aspects of the present disclosure.

FIG. 25 depicts a receptacle and plug in a mated position according to one or more aspects of the present disclosure.

FIG. 26 depicts a receptacle with adjustable pins according to one or more aspects of the present disclosure.

FIGS. 27A-27D depict various views of a locking mechanism according to one or more aspects of the present disclosure.

FIGS. 28A-28B depict an alternative example retention mechanism according to one or more aspects of the present disclosure.

FIGS. 29A-29B depict a top view and bottom view of an example leaf spring retention mechanism according to one or more aspects of the present disclosure.

FIGS. 30A-30B depict example self-aligning mechanics according to one or more aspects of the present disclosure.

FIG. 31 depicts an example detachable connector according to one or more aspects of the present disclosure.

FIG. 32 depicts a micro aligner on a PIC according to one or more aspects of the present disclosure.

FIG. 33 depicts a receptacle on top of a PIC and micro aligner according to one or more aspects of the present disclosure.

FIG. 34 depicts a plug assembly and receptacle in a sliding position according to one or more aspects of the present disclosure.

FIG. 35 depicts a plug and socket in a mated position according to one or more aspects of the present disclosure.

FIG. 36 depicts a bottom view of an example plug assembly according to one or more aspects of the present disclosure.

FIG. 37 depicts a bottom view of an example plug assembly according to one or more aspects of the present disclosure.

FIG. 38 depicts an example of a detachable plug assembly in a receptacle according to one or more aspects of the present disclosure.

FIG. 39 depicts a detachable plug during extraction according to one or more aspects of the present disclosure.

FIG. 40 shows an example optical scheme according to one or more aspects of the present disclosure.

FIG. 41 shows an exemplary method for effecting a detachable optical connection between one or more optical fibers and PIC according to one or more aspects of the present disclosure.

FIG. 42 shows an exemplary method for disconnecting a detachable photonic plug from a receptacle and PIC according to one or more aspects of the present disclosure.

### DETAILED DESCRIPTION

The accompanying drawings, which form a part hereof, show examples of the disclosure. It is to be understood that the examples shown in the drawings and/or described herein are non-exclusive and that there are other examples of how the disclosure may be practiced.

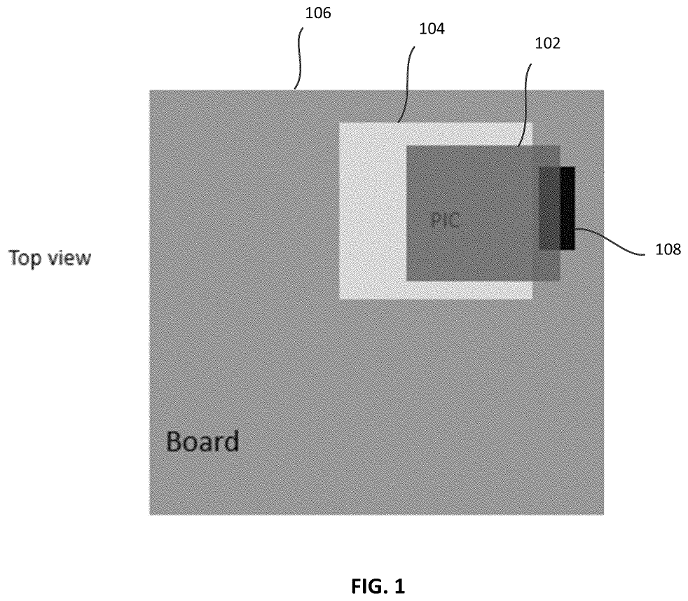

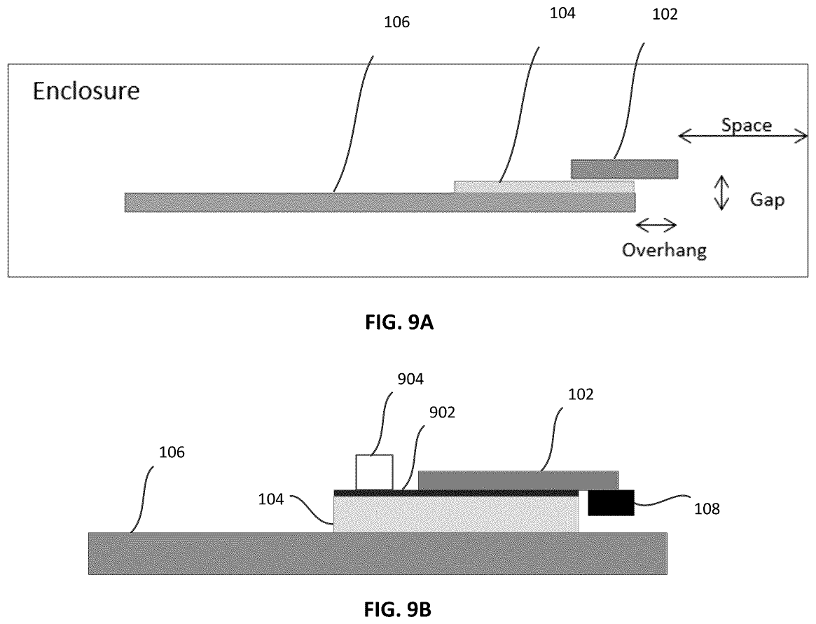

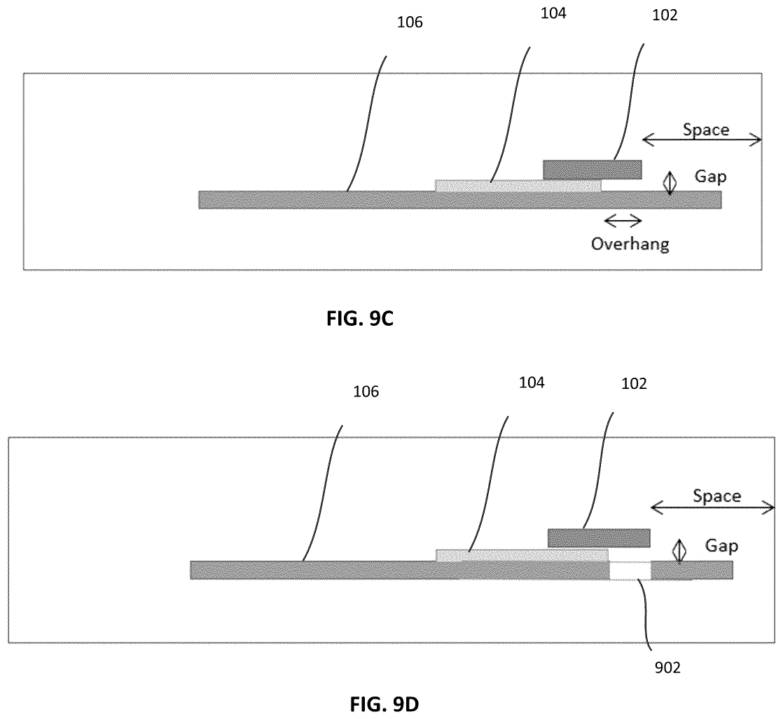

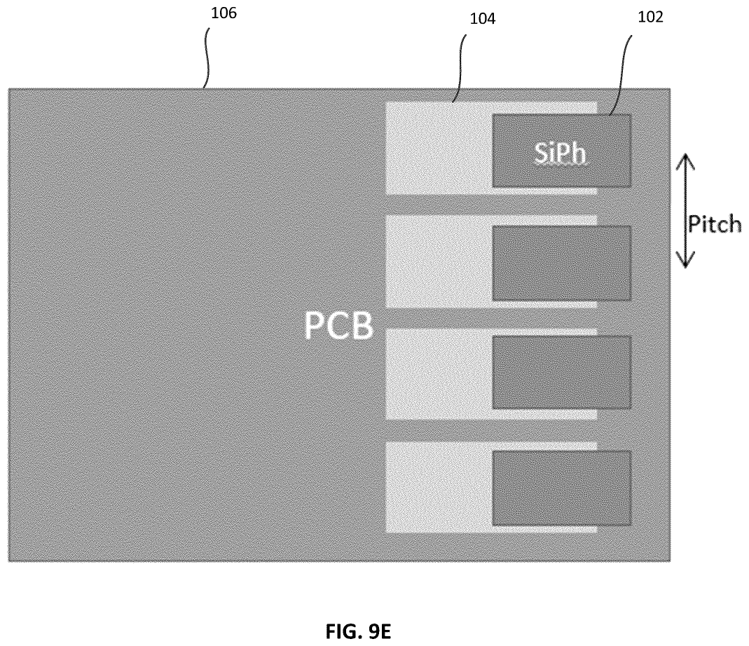

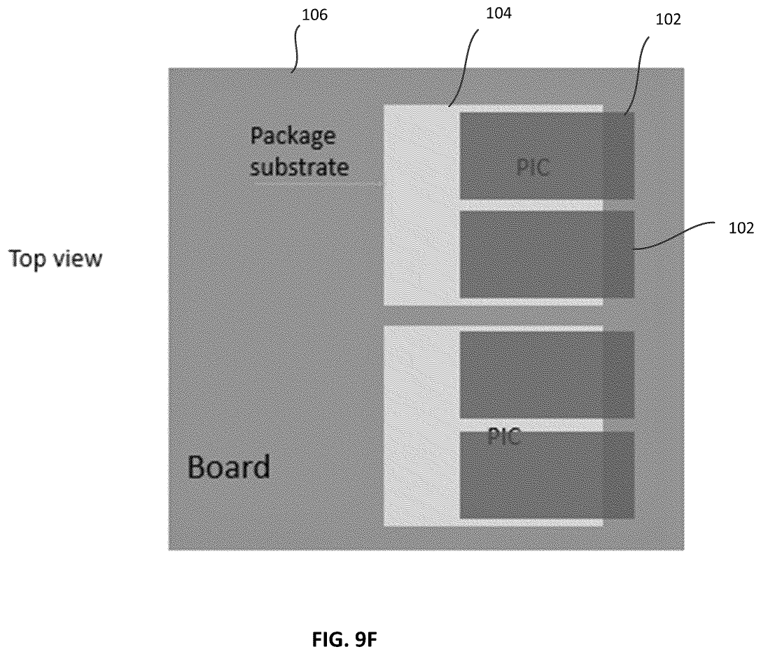

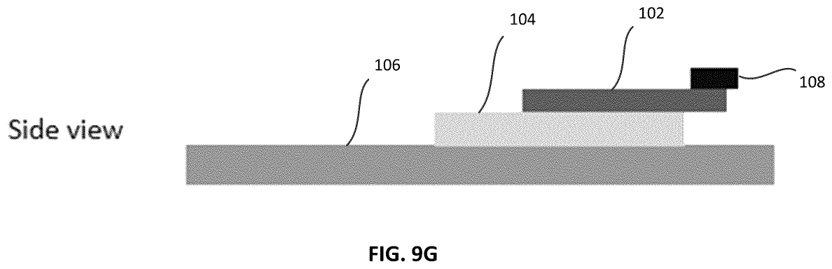

FIG. 1 depicts an example photonic integrated circuit (PIC) 102 connected to a package substrate 104 (e.g., organic substrate, printed circuit board (PCB), other substrate, etc.) and a main board 106 according to one or more aspects of the present disclosure. The PIC 102 may be in one or more of electrical and/or optical connection with the package substrate 104 and/or the main board 106. Such electrical and/or optical connection may be facilitated by active and or passive electrical and/or optical elements. For example, electrical and/or optical connection between the components may be facilitated by electrical and/or optical vias, solder bumps, electrical traces, etc. Additionally or alternatively, the package may comprise an electrical interposer (see, e.g., electrical interposer 902 in FIG. 9B) substrate disposed between the PIC 102 and the package substrate 104. The electrical interposer 902 may additionally host one or more electronic integrated circuits (EIC) (see, e.g., EIC 904 in FIG. 9B). The electrical interposer 902 may facilitate electrical connection between the PIC 102 and the package substrate 104. The electrical interposer 902 may additionally facilitate electrical connection between any combination of the PIC 102, the package substrate 104, and any of the one or more EICs, 904, hosted on the electrical interposer.

The main board 106 may comprise, for example, an electronic integrated circuit (EIC) (e.g., an application-specific integrated circuit (ASIC)), an interposer, a multi-chip-module (MCM), a printed circuit board (PCB), or any other optical and or electronic interconnection medium and/or substrate.

Optical components may be optically coupled to the PIC 102. Examples of optical components may include but are not limited to, optical waveguides, optical fibers (e.g., single-mode fibers, multimode fibers, few-mode fibers, SiPh chips, other PICs, etc.), lasers, grating couplers, etc. Optical components may be optically coupled to the PIC 102 via an optical coupler. Examples of optical couplers may be found in commonly assigned U.S. patent application Ser. No. 17/989,303, and U.S. application Ser. No. 17/512,200, the contents of which (both applications) are incorporated herein by reference in their entirety.

Referring to FIG. 1, depending on packaging concerns and configurations, it may be advantageous to connect the optical components to the bottom side of the PIC 102 (e.g., the side closest to the package substrate 104 and/or the main board 106. Such a bottom-side connection may reduce the footprint of the overall package. For example, the PIC 102 may hang over the package substrate 104 and or main board 106. The optical components (e.g., optical fibers) may be connected (e.g., via photonic plug 108) to the bottom side of the PIC 102.

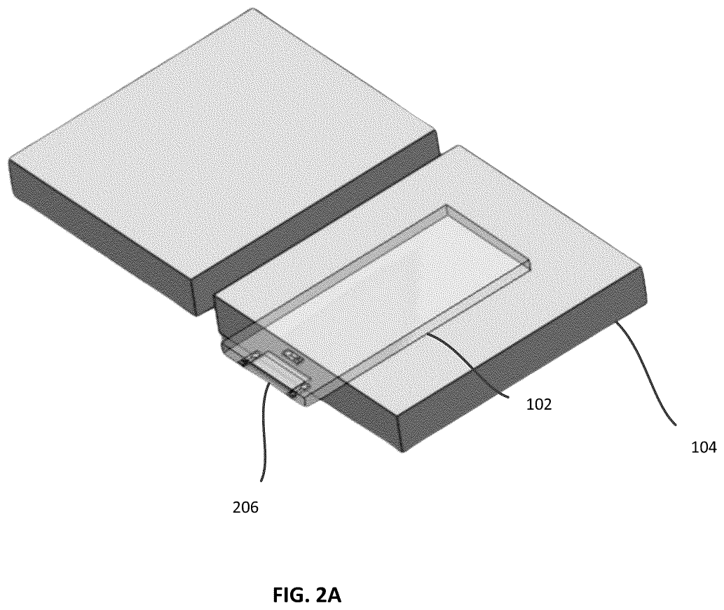

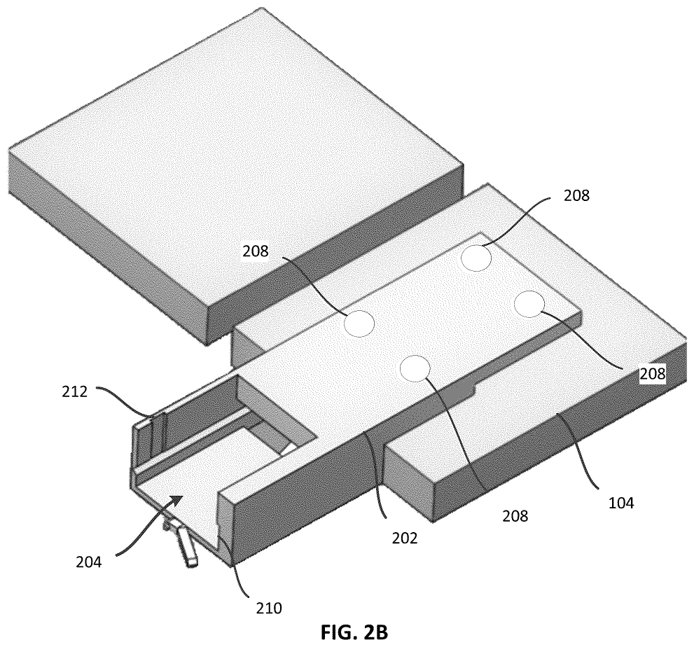

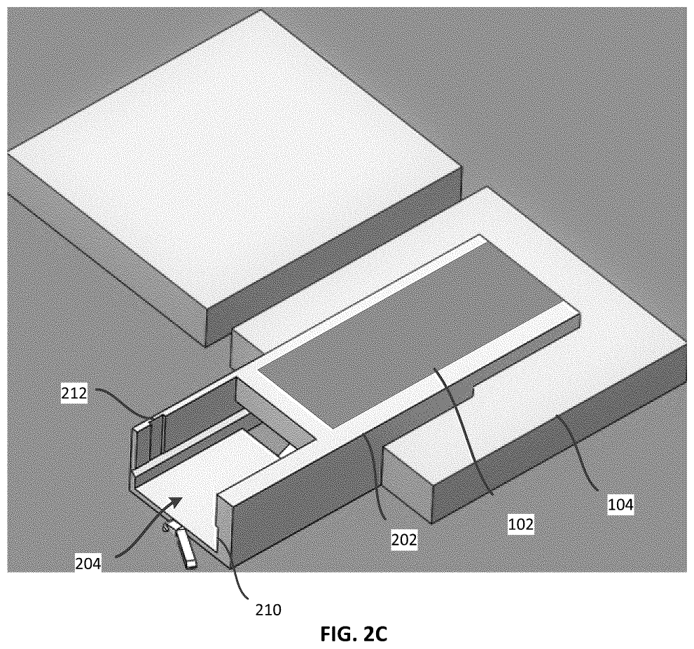

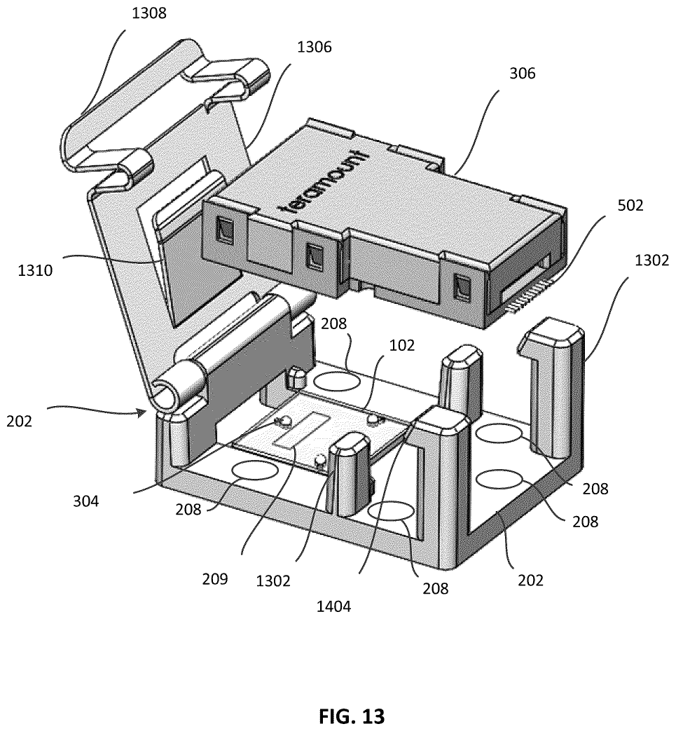

FIG. 2A depicts an example PIC 102 connected to a package substrate 104. Referring to FIG. 2A, the PIC 102 may have one or more terminus components 206. The PIC terminus component may be referred to as, for example, a transceiver, transmitter/receiver, and/or PIC input/output components. The PIC terminus components 206 may comprise, for example, a waveguide, a grating coupler, a reflective element (e.g., a turning mirror, a turning curved mirror (TCM), a laser, etc. Referring to FIG. 2A, the PIC terminus components 206 may be disposed on the underside of the PIC 102. Alternatively, the mating surface of the PIC 102 (e.g., to mate with the mating surface of the photonic plug 108) may be on the underside of the PIC 102; however, the PIC terminus components 206 may be elsewhere in or on the PIC 102. (in alternative configurations, for example, as depicted and described with respect to FIGS. 13-17, the mating surface of the PIC 102 may be on the upper side thereof). (Additionally, a person of ordinary skill will recognize that the terms bottom-side, underside, top-side, and upper-side (and the like) are merely used for purposes of description and should not be understood as limiting). FIG. 2B depicts a bottom-side optical coupler receptacle 202 attached to the example PIC 102 and package substrate 104 of FIG. 2A according to one or more aspects of the present disclosure. Referring to FIG. 2B, the receptacle 202 may be attached to (e.g., bonded to) the top side of the PIC 102 (hidden from view in FIG. 2B between the receptacle 202 and the package substrate 104). Additionally or alternatively, the receptacle 202 may be in contact with, but not bonded to, the PIC 102.

FIG. 2C depicts an alternate configuration of an example bottom-side optical coupler receptacle 202. Referring to FIG. 2C, the receptacle 202 may not cover the PIC 102. According to such a configuration, the receptacle may be attached to the package substrate 104 and/or the main board (not depicted) and/or one or more side surfaces of the PIC 102. The receptacle 202 may comprise a cutout to accommodate the PIC 102. The receptacle may comprise one or more sockets 204 to facilitate the detachable connection of optical components (e.g., attached to a photonic plug and/or plug assembly) as described below. The sockets 204 may comprise horizontal rails 210 and vertical rails 212. The horizontal rails 210 and vertical rails 212 may assist installation of the photonic plug and or plug assembly in the socket 204, as described hereinbelow.

The receptacle 202 may be affixed to the main board 106, the package substrate 104, and/or the PIC 102 via one or more of, for example, adhesives, solder bumps, or mechanical anchoring. The receptacle 202 may be accurately placed with respect to the PIC 102 (e.g., SiPh chip). The accurate placement may be achieved, for example, via pick and place techniques. Such techniques may use alignment marks and or PIC 102 die edges to assist in the accurate placement of the receptacle 202. Referring to FIG. 2B, the receptacle 202 may comprise one or more receptacle observation/installation holes 208. The receptacle observation/installation holes 208 may be used, for example, to ensure proper alignment of the receptacle 202 in relation to the underlying PIC 102, package substrate 104, and/or main board 106. Additionally, following placement of the receptacle 202 (and, for example, for fine alignment of the receptacle with the underlying substrates), adhesive and/or epoxy may be flowed into the receptacle observation/installation holes 208 to adhere the receptacle 202 in place.

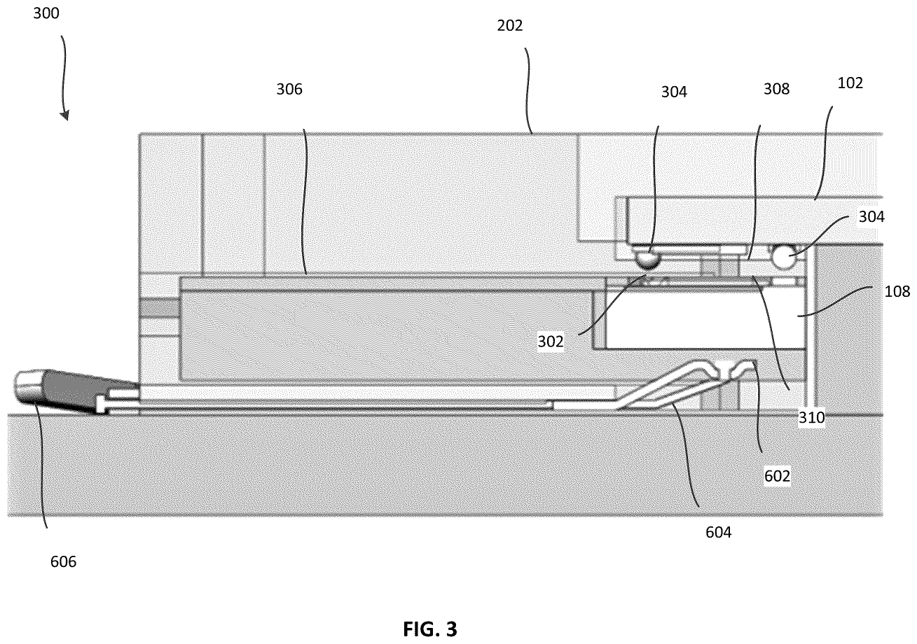

Detachable connectors, systems of detachable connection, and methods of detachable connection are described herein. FIG. 3 depicts a section view of the detachable connector 300 according to one or more aspects of the present disclosure. The PIC 102 may comprise a first side (e.g., a front side). The receptacle 202 may comprise a first side. The first side of the receptacle 202 may abut the first side of the PIC 102. In such a manner, the receptacle 202 and its components (e.g., sockets 204) may be aligned (e.g., coarsely (e.g., roughly) aligned) with the PIC terminus component 209. The receptacle 202 may accept, for example, in the sockets 204, one or more plug assemblies 306 (described in further detail below).

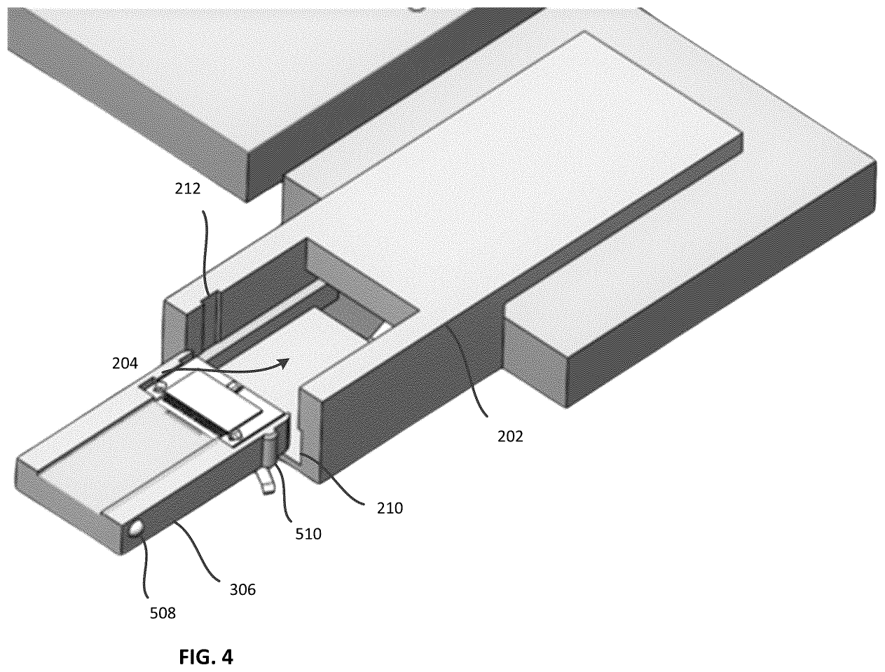

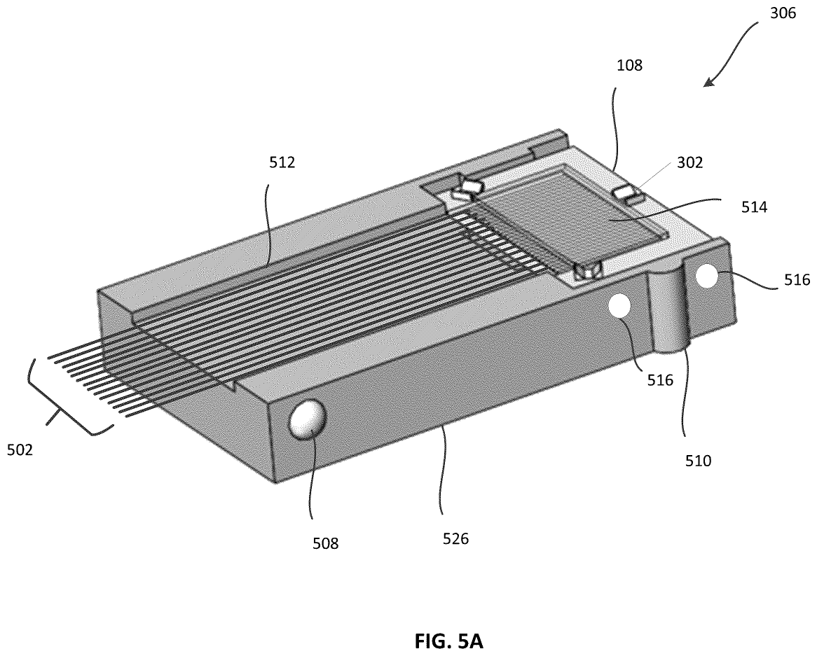

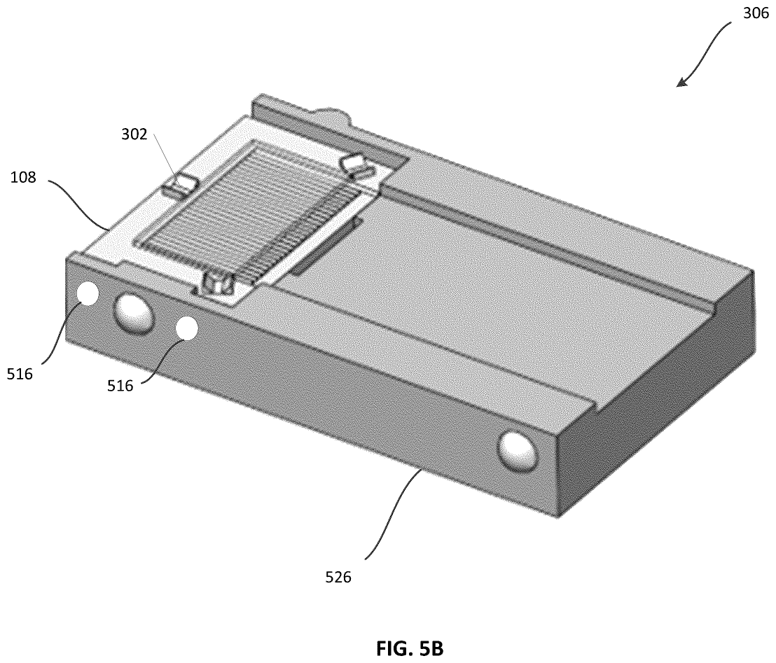

FIG. 4 depicts an example uninstalled detachable connector according to one or more aspects of the present disclosure. Referring to FIG. 4, the receptacle 202 may comprise one or more sockets 204. The sockets 204 may be configured to receive the optical components (e.g., via the plug assembly 306). For example, the optical component(s) may be connected to a plug assembly 306. The plug assembly 306 may mate with and/or connect to the socket 204. The socket 204 may receive the plug assembly 306 and/or the optical component(s) (not shown in FIG. 4, see FIG. 5A depicting optical fibers 502). The sockets 204 may be further configured to align the optical components connected to the plug assembly 306 with the PIC terminus components 206 to facilitate an optical connection between the PIC 102 and the optical component. FIG. 4 depicts a single-socket receptacle 202; however, receptacles 202 may comprise any number of sockets 204 to receive any number of plug assemblies 306.

The receptacle 202 may be connected to the PIC 102, the package substrate 104, and/or the main board 106 in any number of ways. For example, the receptacle 202 may be bonded to the PIC 102. The receptacle 202 may be bonded to the PIC 102, for example, via one or more structural adhesives (e.g., epoxy resin, paste, etc.). The receptacle 202 may be connected to the PIC 102 in any number of other ways. For example, the receptacle 202 may be: clipped to the PIC 102 (for example, using mechanically complementary components), clamped to the PIC 102, soldered to the PIC 102, magnetized in place in relation to the PIC 102, etc., or fabricated with the PIC 102, for example, from the same material as the PIC 102. Additionally or alternatively, the receptacle 202 may be anchored to the PIC 102 via, for example, an intermediate substrate. For example, the intermediate substrate may be soldered and/or otherwise attached, on a first side, to the PIC 102, and the intermediate substrate may be soldered or otherwise attached, on a second side, to the receptacle 202. Although the receptacle 202 is described above as being connected to the PIC 102, the receptacle 202 may additionally or alternatively be connected to the package substrate 104 and/or the main board 106.

The receptacle 202 may be configured to assist heat dissipation from the PIC 102 (e.g., as a heat sink). Accordingly, the receptacle 202 may comprise features to improve its heat-sinking capability (e.g., heat sink fins of any nature). Additionally, the portion of the receptacle 202 attached to the PIC 102 may comprise a material with relatively high thermal conductivity (e.g., copper, aluminum, other metals, etc.). A thermal paste may be used between the receptacle 202 and the PIC 102 to further improve the heat-sinking aspects of the receptacle 202. The thermal paste may be used alone and/or in conjunction with adhesives. The receptacle 202 may comprise one or more materials (e.g., metal or metal and plastic). For example, the portion covering the PIC 102 may comprise one material (e.g., metal), while the portion comprising the sockets 204 may comprise a second material (e.g., plastic). Accordingly, the receptacle 202 may be produced via one or more methods of production. For example, in the case of an all or partially metal receptacle 202, the metal portions may be CNC machined, stamped, molded, 3D printed, etc. In the case of an all or partial polymer receptacle 202, the polymer portions may be, for example, molded, 3D printed, etc.

FIGS. 5A-5B depict different views of an example plug assembly 306 according to one or more aspects of the present disclosure. The plug assembly 306 may comprise a photonic plug 108. One or more optical components (e.g., optical fibers 502) may be connected to the photonic plug 108. Example photonic plugs 108 and additional features are described in more detail in incorporated U.S. patent application Ser. No. 17/989,303. The plug assembly 306 may further comprise a plug cover 526. The photonic plug 108 may be connected to the plug cover 526. For example, the photonic plug 108 may be adhered to, clipped to, clamped to, screwed to, press-fit to, or otherwise connected to the plug cover 526. The plug cover 526 may comprise a void in which the photonic plug 108 may be maintained. The void in the plug cover 526 may comprise features to assist the retention and alignment of the photonic plug 108 within the plug cover 526. While the plug assembly 306 is described in detail herein as comprising plurality parts, it should be understood that the plug may similarly comprise a single part. The single part may comprise all features of the plug assembly 306 described herein. The plug assembly 306 may, for example, comprise a single unitary photonic plug 108 having all features of the plug assembly 306. Additionally, the parts described may be subdivided into additional parts.

The plug cover 526 may be fabricated from any number of materials. For example, the plug cover 526 may be fabricated from metal. According to such a configuration, the plug cover 526 may be CNC machined, molded, 3D printed, or any fabricated with any other metal fabrication method known to those of ordinary skill in the art. Additionally or alternatively, the plug cover 526 may be fabricated from a polymer (e.g., plastic, nylon, etc.). According to such configurations, the plug cover 526 may be fabricated using any polymer fabrication method known to those of ordinary skill in the art. Additionally, or alternatively, the plug may be fabricated from other materials, for example, silicon or epoxy.

The plug cover 526 may additionally comprise coarse (e.g., rough) alignment features for aligning the plug assembly 306 within the receptacle socket 204. The alignment features may assist with alignment of the plug during installation and/or upon final installation (e.g., if the plug assembly 306 is seated in the receptacle 202). For example, coarse alignment features may assist in alignment during installation (e.g., sliding in and out of the socket 204) and upon final installation (e.g., sliding up and down in the socket 204). For example, the plug cover 526 may comprise one or more bonded ball bearings 508. Additionally or alternatively, the plug cover 526 may comprise additional or alternative features (e.g., one or more alignment protrusions 510). The bonded ball bearings 508 and/or the alignment protrusions 510 (e.g., vertical protrusion) may assist the sliding (and/or guiding) into corresponding horizontal rails 210 and/or vertical rails 212 in the receptacle 202 (as described below). Additionally, the plug cover 526 may comprise features to assist alignment and retention of the plug assembly 306 if the plug assembly 306 is fully installed (e.g., seated) in the receptacle 202. For example, the plug cover 526 may comprise one or more alignment protrusions 510. The alignment protrusions 510 may slide into corresponding horizontal rails 210 and/or vertical rails 212 of the receptacle 202. Although certain alignment and mating features have been described, other alignment and mating features may be utilized as will be appreciated by those skilled in the art. Additionally, the receptacle 202 may comprise complementary alignment and retention features to those of the plug cover 526. The plug cover 526 may comprise additional retention features on one or more of its sides, as is described in more detail.

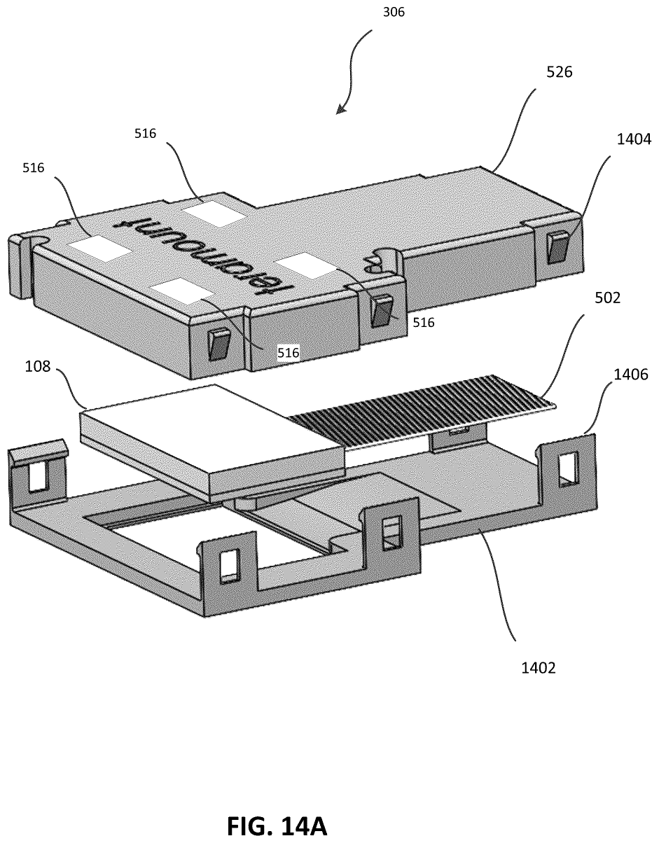

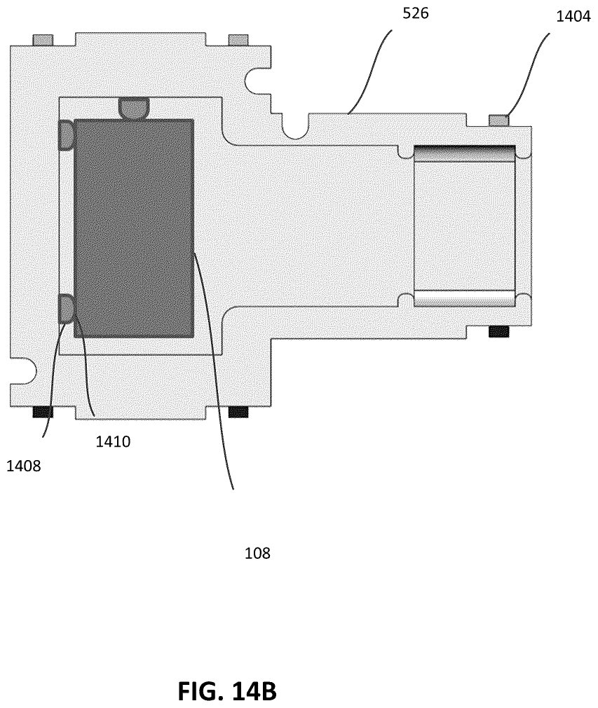

The plug assembly 306 may comprise additional features. For example, the plug assembly 306 may comprise coarse and/or fine alignment features (e.g., coarse and fine alignment features described elsewhere herein) to align the photonic plug 108 within the plug cover 526. For example, the plug cover 526 may be configured (e.g., shaped) to facilitate coarse alignment of the photonic plug 108 within the plug cover 526. For example, the plug cover 526 may comprise a recess substantially complimentarily shaped to the photonic plug 108. Additionally or alternatively, the plug cover may comprise spheres or semi-spheres, and the photonic plug may comprise corresponding v-grooves that may mate with the spheres or semi-spheres, to facilitate fine alignment of the photonic plug 108 within the plug cover 526 (see, e.g., FIG. 14B and associated description). The plug cover 526 may additionally comprise one or more observation/installation holes 516 in one or more of its surfaces. The observation/installation holes 516 may assist installation of the photonic plug 108 in the plug cover 526. For example, the observation/installation holes 516 may be used to check and/or adjust the alignment of the photonic plug 108 within the plug cover 526. Additionally or alternatively, following placement (and, e.g., fine adjustment) of the photonic plug 108 in the plug cover 526, adhesive and/or epoxy may be flowed into the holes to retain the photonic plug 108 in place.

Additionally, as described herein, the photonic plug 108 may be connected to optical components, for example, optical fibers 502 (and/or, e.g., an optical fiber ribbon). As described in more detail in herein incorporated U.S. application Ser. No. 17/989,303, the photonic plug 108 may comprise various features. For example, the photonic plug 108 may comprise optical elements (e.g., one or more tilted mirrors, and/or one or more optical focusing elements (e.g., curved mirrors) to assist in self-aligning optics with the connected PIC 102. Additionally, the photonic plug 108 may comprise one or more trenches 514 (e.g., v-grooves). The trenches 514 may receive and assist alignment of the optical fibers 502. The optical fibers 502 may be held in the trenches, for example, via a bonding agent (e.g., adhesive, epoxy, etc.).

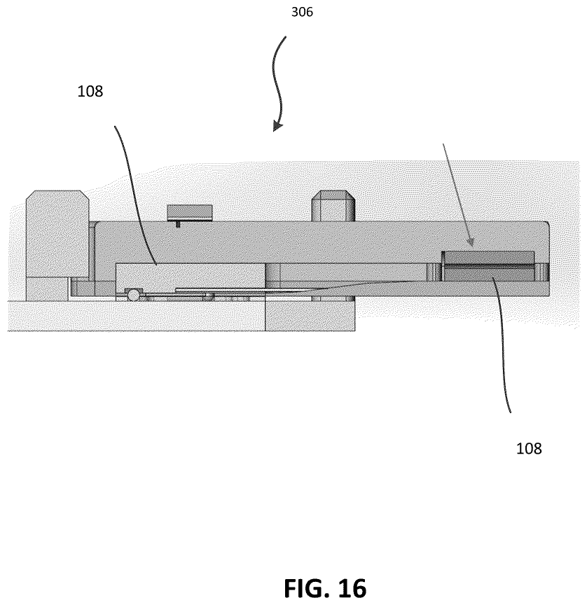

The plug assembly 306 may be mechanically configured to accommodate the optical fibers 502. For example, the plug cover 526 may comprise a recess 512 to accommodate the routed optical fibers 520. Additionally, the plug assembly 306 may further comprise one or more strain relief features. For example, the plug assembly 306 may further comprise a rubber grommet which may be installed around the optical fibers 502 attached to the photonic plug 108 (see, e.g., FIG. 16 and associated description). The rubber grommet may provide strain relief for the optical fibers 502 and may hold the optical fibers 502 in place to resist movement of the optical fibers (and components attached thereto, for example, the photonic plug 108) within the plug assembly 306. Additionally or alternatively, other strain relief materials and/or configurations may be used. For example, adhesive, epoxy, and/or other material may be deposited and/or placed in the recess 512, following optical fiber installation, to provide retention and/or strain relief of the optical fibers 502 (e.g., to reduce mechanical pressure on the optical fibers 502 at the area of connection with the photonic plug 108).

Referring again to FIG. 4, the plug assembly 306 may be installed in the receptacle 202. The plug assembly may be slid into the socket 204 of the receptacle 202. The coarse alignment features of the plug assembly 306, for example, the bonded ball bearing 508 and/or the alignment protrusion 510, may slide into the corresponding structures of the socket 204, for example, the horizontal rail 210. If fully inserted into the socket 204, the plug assembly 306 may be pushed or pulled upward (as described in more detail herein) into its final seated position. The coarse alignment features (e.g., bonded ball bearing 508 and/or alignment protrusion 510) of the plug assembly 306, for example, the bonded ball bearings 508 and/or the alignment protrusions 510, may slide (e.g., upward), and may be guided within the corresponding structure of the receptacle 202, for example, the vertical rail 212.

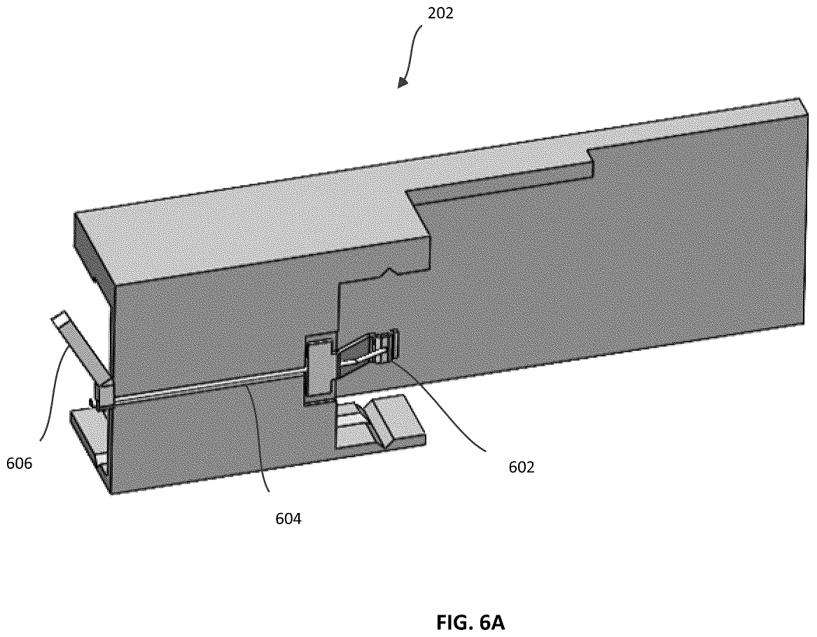

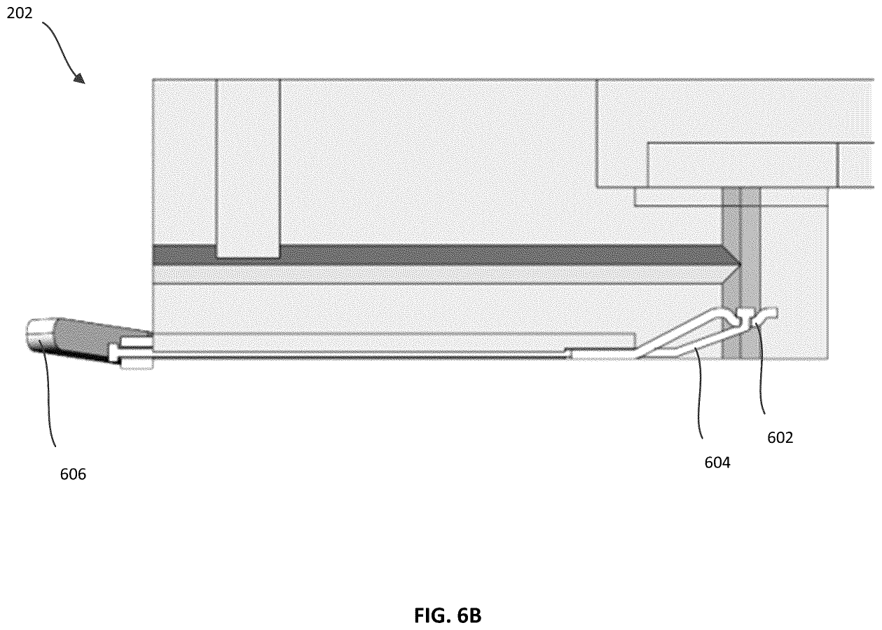

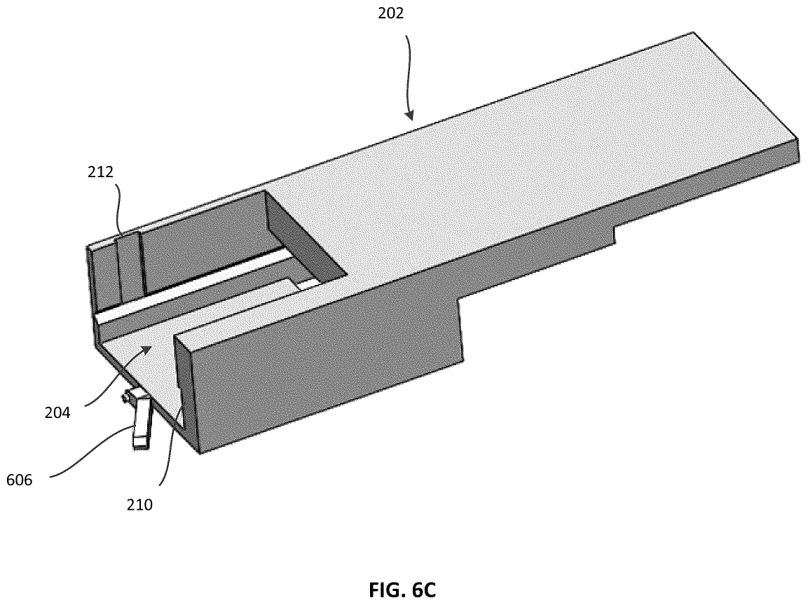

FIGS. 6A-6C depict various views of an example receptacle 202 according to one or more aspects of the present disclosure. Referring to FIG. 6A, the receptacle 202 may comprise one or more plug assembly 306 retention features to assist in securely retaining the plug assembly 306 in the socket 204. The plug assembly 306 retention features may additionally or alternatively assist with the optical alignment of the optical elements of the photonic plug 108 and the PIC 102.

Many different plug assembly 306 retention features are considered. For example, the receptacle 202 may comprise a preloaded leaf spring 602 for each socket 204 and/or for multiple sockets 204. The leaf spring 602 may be disposed in a void in the bottom portion of the receptacle 202. The leaf spring 602 may rest in the path of the plug assembly 306. If the plug assembly 306 is inserted into the socket 204, the plug assembly 306 may displace the leaf spring 602, and the leaf spring 602 may return toward its starting position once the plug is fully seated in the socket 204. In this manner, the leaf spring 602 may retain the plug assembly 306 in the socket 204.

A wire 604 may be connected to the leaf spring 602. The wire 604 may be metal (for example, steel) or another material capable of accepting sufficient tension. The wire 604 may route from the leaf spring 602 to the front side of the receptacle 202. At the front side of the receptacle 202, the wire 604 may be connected to a lever 606. If the lever 606 is displaced (e.g., by being pushed forward or backward), the lever 606 may assert a pulling force on the wire 604, which, in turn, may assert a pulling force on the spring 602. The pulling force on the spring 602 may displace the spring 602 from the path of the plug assembly 306. While the lever 606 is depicted, any method of asserting a pulling force on the spring 602 may be used (e.g., a knob).

Referring again to FIG. 3, upon installation of the plug assembly 306 in the socket 204, during sliding, if the plug assembly 306 reaches the area of the leaf spring 602, the plug assembly 306 may push the leaf spring 602 out of its path. Alternatively, lever 606 may be depressed (or pulled) to remove the leaf spring 602 from the path of the sliding plug assembly 306. Upon reaching the end of the travel, the leaf spring 602 may return (and/or be returned) to its resting position and assist in holding the plug assembly 306 in place (e.g., in its seated position). Alternatively, the lever 606 may be released to allow the leaf spring 602 to return to toward its resting position. To this end, the plug assembly 306 may comprise a spring-accepting feature. For example, the spring-accepting feature may be configured to be mechanically complementary to a surface of the leaf spring 602. For example, if the leaf spring 602 pushes against the spring-accepting feature, the leaf spring 602 may assist in the retention of the plug assembly 306 in its seated position.

Additionally, the photonic plug 108, receptacle 202, and or PIC 102 may comprise fine alignment features. For example, the photonic plug 108 may comprise, for example, on its top side, one or more v-grooves 302. Although the v-grooves 302 are described as being disposed on the photonic plug 108, the v-grooves 302 may be disposed on one or more of any surfaces of the plug assembly 306. Although the v-grooves 302 are depicted as two-dimensional v-grooves 302, they may similarly comprise three-dimensional v-grooves 302 (e.g., pyramidal in shape). The v-grooves 302 may be accurately fabricated on the photonic plug 108 die via, for example, wafer-level processes (e.g., wafer-level fabrication and/or installation process). Such processes may simply ensure high-accuracy placement of the v-grooves 302 (e.g., fine alignment features) with respect to the remainder of the photonic plug 108. Although the fine alignment features on the photonic plug 108 side are described herein as v-grooves 302, they are not so limiting. For example, the fine alignment features on the photonic plug 108 side (e.g., described herein as v-grooves 302) may be otherwise shaped and/or configured. For example, the fine alignment features of the photonic plug 108 side may be, for example, cup-shaped, u-groove shaped, trenches of any shape, etc. (e.g., instead of and/or in addition to v-grooves 302).

In association with the v-grooves 302, the PIC mating surface 308 (e.g., the mating surface of the PIC), to which the photonic plug mating surface 310 (e.g., the mating surface of the photonic plug) may mate, may comprise spheres 304 and/or semi-spheres. The spheres 304 of the PIC side may align with the v-grooves 302 of the plug side. In the seated position, the plug assembly 306 (and the photonic plug 108 therein) may be pushed and/or pulled toward the mating surface of the PIC 102. For example, the leaf spring 602 may engage the underside of the plug assembly 306, pushing the plug assembly 306 toward the PIC 102. The v-grooves 302 of the plug assembly 306 may engage the spheres 304 of the PIC 102. The engagement of the spheres 304 and the v-grooves 302 may assist and/or accomplish fine alignment between the photonic plug 108 and the PIC 102. Although the spheres 304 are depicted as being disposed on the PIC 102, the spheres 304 can be disposed elsewhere (e.g., a surface of the receptacle 202). The fine alignment features may be configured differently. For example, rod-shaped alignment features may be used alternatively to or in addition to the spheres 304. Although the v-grooves 302 are described as being disposed on the photonic plug 108 side, and the spheres 304 are described as being disposed on the PIC 102 side, it will be appreciated that either of the features can be disposed on either side. Other complementary fine alignment features between the PIC 102 and the plug assembly 306 are contemplated herein. The spheres 304 may be fabricated on the PIC 102 (e.g., the SiPh chip) via wafer level process (e.g., wafer level fabrication and/or installation process). Such processes may ensure high-accuracy placement of the spheres 304 (e.g., fine alignment features) with respect to the remainder of the PIC (e.g., the terminus components).

The plug assembly 306 may be released and removed from the receptacle 202. The steps for removing the plug assembly 306 from the receptacle 202 may be the substantial reverse of the steps to install the plug assembly 306. For example, the lever 606 may be depressed or pulled, which may cause a pulling force on the wire 604. The pulling force on the wire 604 may cause a pulling force on the leaf spring 602. The leaf spring 602 may be pulled away from the plug assembly 306. The plug assembly 306 may be displaced (e.g., drop) from its seated position. The fine alignment features of the PIC 102 side (e.g., spheres 304) and the plug assembly 306 side (e.g., v-grooves 302) may disengage. The plug assembly 306 may be removed (e.g., slid out of) the receptacle 202.

A person of ordinary skill will appreciate that the stiffness of the leaf spring 602 may be adjusted to optimize various parameters. For example, the leaf spring 602 stiffness may be adjusted in consideration of the force applied to the bottom of the plug assembly 306 and, in turn, between the mating surfaces (e.g., mating surfaces 308 and 310) of the photonic plug 108 and the PIC 102 and/or the fine alignment features. Thus, it may be desirable to configure the leaf spring 602 to apply sufficient force to the plug assembly 306 to engage the fine alignment features (e.g., v-grooves 302 and spheres 304) without damaging the fine alignment features and/or the mating surfaces. Further still, the stiffness of the leaf spring 602 may be adjusted in consideration of material deformation under the spring force. Accordingly, the materials used in the plug assembly 306 and/or the receptacle 202 may be considered in designing the leaf spring 602 stiffness. Additionally, the stiffness may be adjusted in consideration of the force required to displace the lever 606 (and, in turn, the leaf spring 602). The lever arm size may also be adjusted in consideration of such a force (e.g., the lever arm may be elongated to reduce the required input force on the lever 606 to displace the leaf spring 602).

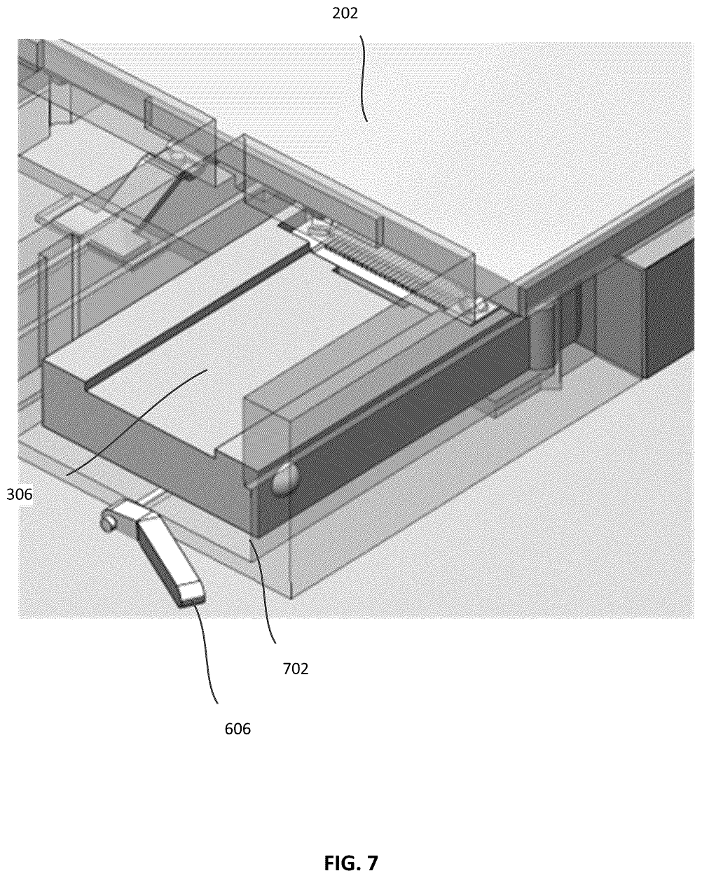

FIG. 7 depicts an example detachable connector in a seated configuration according to one or more aspects of the present disclosure.

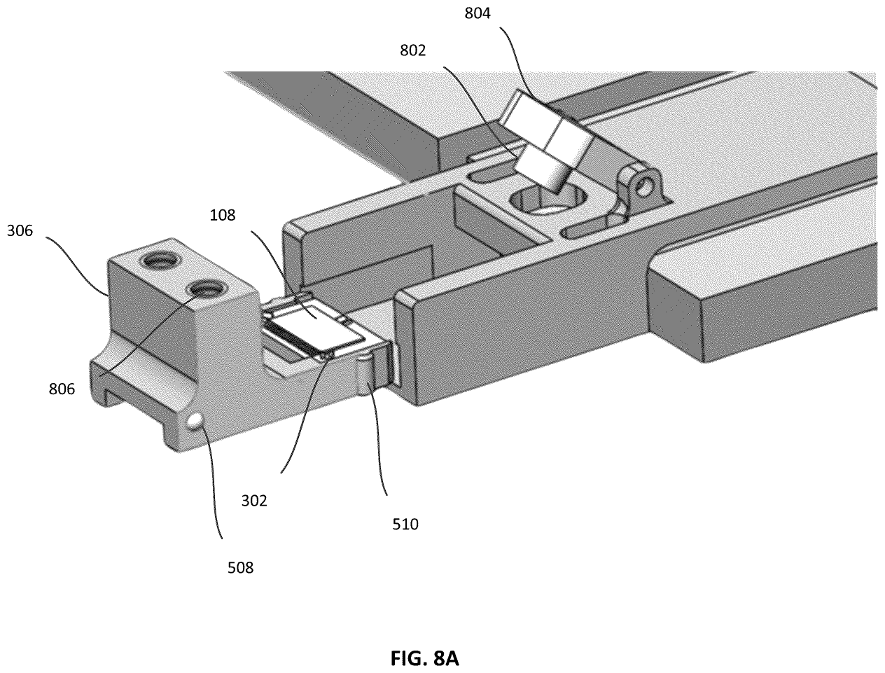

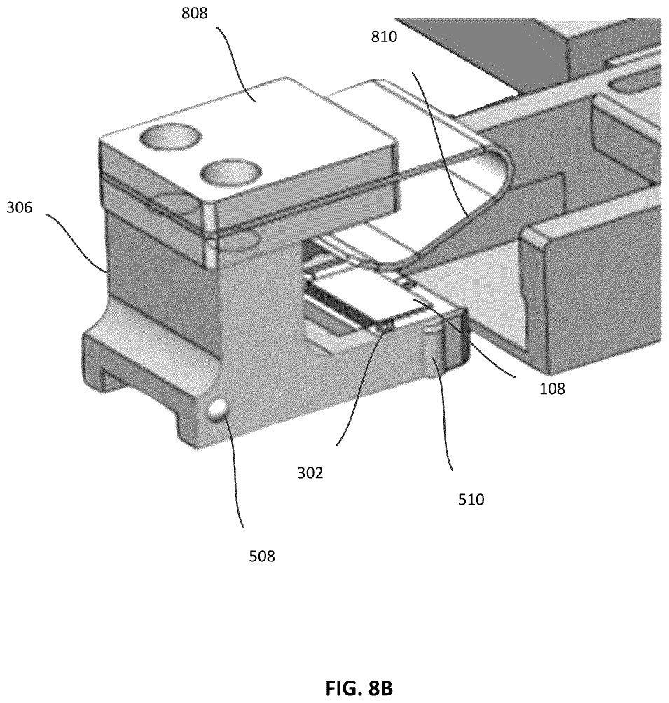

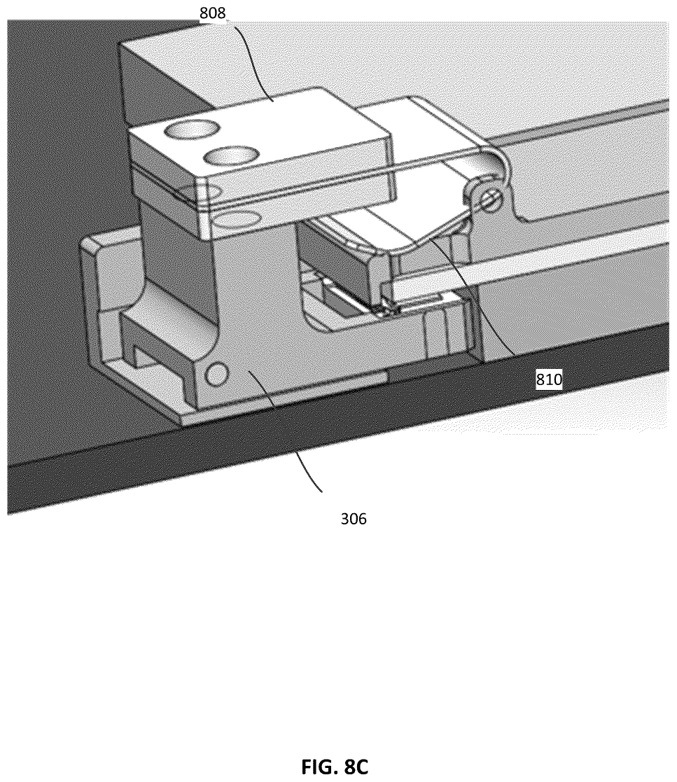

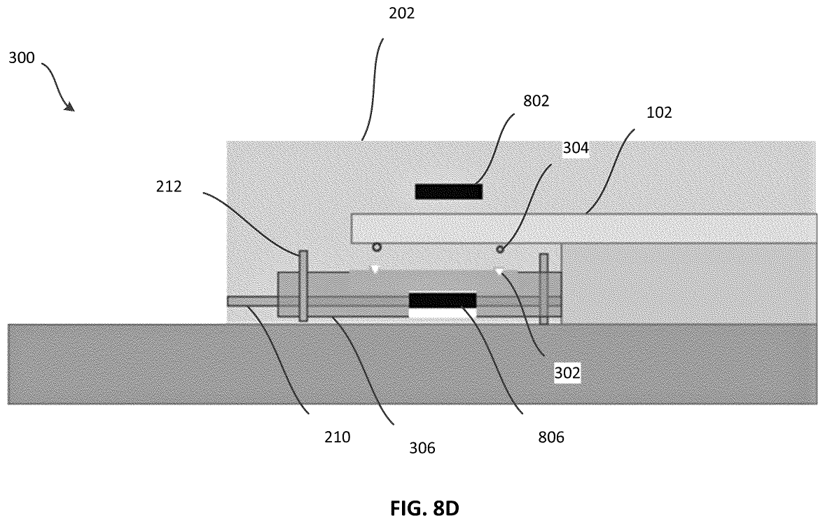

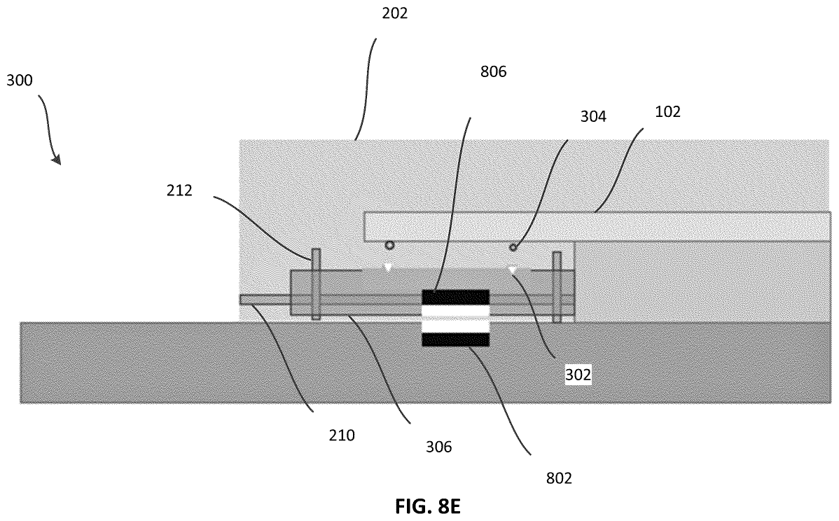

FIGS. 8A-8C depict example alternative plug assembly 306 retention features according to one or more aspects of the present disclosure. Referring to FIG. 8A, magnets may be used to retain the plug assembly 306 in its seated position within the receptacle 202. The receptacle 202 may comprise one or more first magnets 802 (and/or a magnetically attracted element). The first magnet 802 may be disposed in a first magnet assembly 804. The first magnet assembly 804 may be rotationally mated (e.g., via a hinge or the like) to the receptacle 202. The first magnet assembly 804 may be rotated towards and away from the plug assembly 306. Alternatively, the first magnet assembly 804 may be slidably mated to the receptacle 202 and may be slid toward and away from the plug assembly 306. Alternatively, the first magnet 802 may be fixed (e.g., as depicted in FIGS. 8D and 8E). One or more second magnets 806 (and/or magnetically attracted elements) may be disposed in and/or on the plug assembly 306.

As described above, the plug assembly 306 may be slid into the socket 204 of the receptacle 202. The first magnet 802 (e.g., of the first magnet assembly 804) may be moved (e.g., rotated, slid) toward the plug assembly 306. The first magnet 802 may be attracted to the second magnet 806 of the plug assembly 306 (e.g., the second magnet 806). The attractive magnetic force may apply a force on the plug assembly 306 toward the first magnet 802. Additionally, the attractive magnetic force may apply a force on the plug assembly 306 in the direction of the PIC 102. The attractive force may assist the fine alignment of the plug assembly 306 (e.g., the photonic plug 108) with the PIC 102 (e.g., PIC terminus components 206). For example, as described above, the pulling force may cause the plug assembly 306 to move toward the PIC 102 (e.g., toward the seated configuration), and the fine alignment features of the PIC 102 side (e.g., spheres 304) and the plug assembly 306 side (e.g., v-grooves 302) may engage.

Referring to FIGS. 8B and 8C, other retention features are contemplated. For example, the plug assembly 306 may comprise a plug spring assembly 808, and the plug spring assembly 808 may comprise a plug spring 810. The plug spring 810 may be disposed above (and/or below) the photonic plug 108 and/or a portion of the plug assembly 306. If the plug assembly 306 is installed in the socket 204 of the receptacle 202, the plug spring assembly 808 may contact a surface of the receptacle 202. The plug spring 810 may deform and apply a force to the surface of the receptacle 202. Accordingly, the force applied to the surface of the receptacle 202 may pull (or push) the plug assembly 306 in the direction of the PIC 102. As with the alternative retention features, the force applied to the plug assembly 306 in the direction of the PIC 102 may assist in fine alignment of the photonic plug 108 (e.g., v-grooves 302) and the PIC 102 (e.g., corresponding spheres 304 and/or semi-spheres). The surface of the receptacle 202 that contacts the plug spring 810 may further include features to mate with the plug spring 810. For example, the surface of the receptacle 202 may include a recess with which the spring 810 may mate (e.g., fit into) to further assist retention of the plug assembly 306 in the receptacle socket 204.

A person of ordinary skill will appreciate that the stiffness of the plug spring 810 may be adjusted to optimize various parameters. For example, the spring 810 stiffness may be adjusted in consideration of the force applied to the bottom of the plug assembly 306 and, in turn, between the mating surfaces of the photonic plug 108 and the PIC 102 (e.g., the fine alignment features). Thus, it may be desirable to configure the spring 810 to apply sufficient force to the plug assembly 306 to engage the fine alignment features without damaging the fine alignment features and/or the mating surfaces. Further still, the stiffness of the spring 810 may be adjusted in consideration of material deformation under the spring force.

FIG. 8D depicts an alternate configuration of a detachable optical coupler 300 according to one or more aspects of the present disclosure. Referring to FIG. 8D, the first magnet 802, and/or the second magnet 806 may be fixed. The first magnet 802 may be disposed in the receptacle 202. The first magnet may be disposed above the socket 204 and plug assembly 306. The second magnet 806 may be installed in the plug assembly 306. Upon installation of the plug assembly 306 into the socket 204, the first magnet 802 and the second magnet 806 may align. The first and second magnets, 802 and 806, may be arranged to attract one another (e.g., opposite poles of the magnets aligned). The attractive magnetic force between the first magnet 802 and the second magnet 806 may cause the plug assembly to move (e.g., slide) toward the PIC 102 (e.g., being guided by coarse alignment features of the plug assembly and the vertical rail 212). The v-grooves 302 of the photonic plug 108 may engage the spheres 304 of the PIC 102, finely aligning the PIC 102 components and the photonic plug 108 components in the seated position. The attractive magnetic force may act to hold the plug assembly 306 in the seated position. While both the first magnet 802 and second magnet 806 have been described as magnets per se, it should be understood that one of the first or second magnets 802 or 806 may be replaced by a magnetically attractive material (e.g., a ferrous metal). Although the first magnet 802 has been described as being in a fixed relationship with the receptacle 202, the first magnet 802 may be movably (e.g., slidably and/or rotationally) mated with the receptacle 202. Similarly, although the second magnet 806 has been described as being in a fixed relationship with the plug assembly 306, the second magnet 806 may be movably (e.g., slidably and/or rotationally) mated with the plug assembly 306.

FIG. 8E depicts an alternate configuration of a detachable optical coupler 300 according to one or more aspects of the present disclosure. FIG. 8E depicts an example configuration in which the magnets 802 and 806 are arranged such that an attractive force between the first and second magnets 802 and 806 acts to hold the plug assembly 306 in the seated position. Referring to FIG. 8E, the magnets 802 and 806 may be alternatively configured such that a repulsive force between the first and second magnets 802 and 806 may act to move and/or hold (e.g., push) the plug assembly in the seated position. The first magnet 802 may be disposed (e.g., in a fixed or moveable manner) in the receptacle 202 below the socket 204 and the plug assembly 306. The second magnet 806 may be disposed in the plug assembly 306. The first and second magnets 802 and 806 may be arranged to repel each other (e.g., similar poles of the magnets aligned). Upon installation of the plug assembly 306 in the socket 204, the first and second magnets 802 and 806 may align and repel one another. The repulsive force of the first and second magnets 802 and 806 may push the plug assembly toward the PIC 102 (e.g., being guided by the vertical rails 212). The spheres 304 of the PIC 102 side may engage with the v-grooves 302 of the photonic plug 108 side to finely align the PIC 102 and the photonic plug 108. The repulsive force of the first magnet 802 with the second magnet 806 may act to hold the plug assembly in this seated position. Although the first magnet 802 has been described as being in a fixed relationship with the receptacle 202, the first magnet 802 may be movably (e.g., slidably and/or rotationally) mated with the receptacle 202. Similarly, although the second magnet 806 has been described as being in a fixed relationship with the plug assembly 306, the second magnet 806 may be movably (e.g., slidably and/or rotationally) mated with the plug assembly 306.

Like the stiffness of the leaf spring described above, a person of ordinary skill will appreciate that the attractive and/or repulsive force between the first magnet 802 and the second magnet 806 (e.g., of FIGS. 8D and 8E) may be adjusted to optimize various parameters. For example, the attractive and/or repulsive force between the first magnet 802 and the second magnet 806 may be adjusted in consideration of the force applied to the mating surfaces (e.g., mating surfaces 308 and 310) of the photonic plug 108 and the PIC 102 and/or the fine alignment features. Thus, it may be desirable to configure the first and second magnets 802 and 806 to apply sufficient force to the plug assembly 306 to engage the fine alignment features (e.g., v-grooves 302 and spheres 304) without damaging the fine alignment features and/or the mating surfaces. Further still, the attractive and/or repulsive force between the first magnet 802 and the second magnet 806 may be adjusted in consideration of material deformation under the magnetic force. Accordingly, the materials used in the plug assembly 306 and/or the receptacle 202 may be considered in designing the attractive and/or repulsive force.

FIGS. 9A-9F depict example PIC 102, package substrate 104, and main board 106 arrangements according to one or more aspects of the present disclosure. As described, one or package substrates 104 may be connected (e.g., electrically and/or optically) to the main board 106. One or more SiPh chips (e.g., comprising PICs 102) may be connected (e.g., electrically and/or optically) to each package substrate 104. A plurality of package substrates 104 and/or PICs 102 may be attached to a main board 106, for example, as depicted in FIGS. 9E and 9F. Referring to FIGS. 9A and 9B, the PIC 102 may overhang either or both of the package substrate 104 and/or the main board 106. The PIC terminus components 206 (e.g., transceiver, PIC input/output components) may be disposed on the underside of the PIC 102 in the area of the overhang. The receptacle 202 may assist the photonic plug 108 mating to the underside of the PIC 102 as described herein.

Referring to FIGS. 9B-9G, the PIC 102 may overhang the package substrate 104 and/or the electrical interposer 902 but not the main board 106. Accordingly, the plug assembly 306 may be installed between the PIC 102 and the main board 106. As described herein, the photonic plug 108 may connect to the underside of the PIC 102 (e.g., the area overhanging the package substrate 104). Referring to FIG. 9D, according to a configuration in which the PIC 102 overhangs the package substrate 104 but not the main board 106, it may be advantageous for the main board 106 to comprise an opening 902 (e.g., a window) in the area opposing the PIC 102 and or the terminus components 206 of the PIC 102. This opening 902 may be advantageous to gain access to the optical components of the PIC 102 and/or the plug assembly 306 (e.g., for cleaning purposes, for alignment purposes, for maintenance purposes, etc.). Referring to FIG. 9E, multiple PICs 102 may be optically and/or electrically connected to a single package substrate 104. Referring to FIG. 9G, the detachable optical couplers 300, and components of the present disclosure may be configured to connect to the top side of the PIC 102.

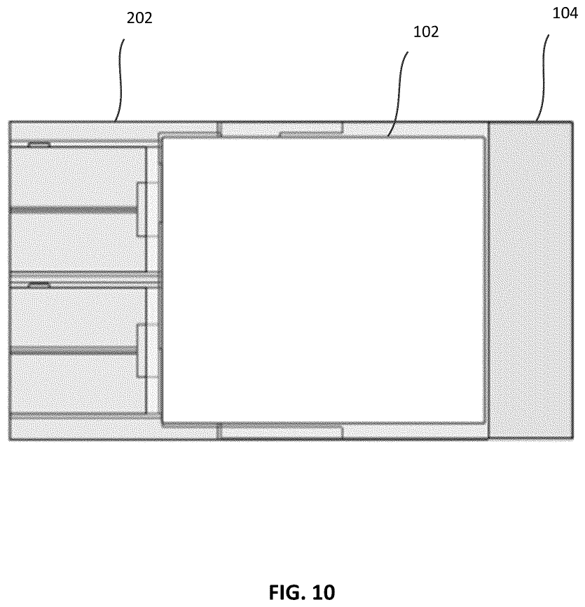

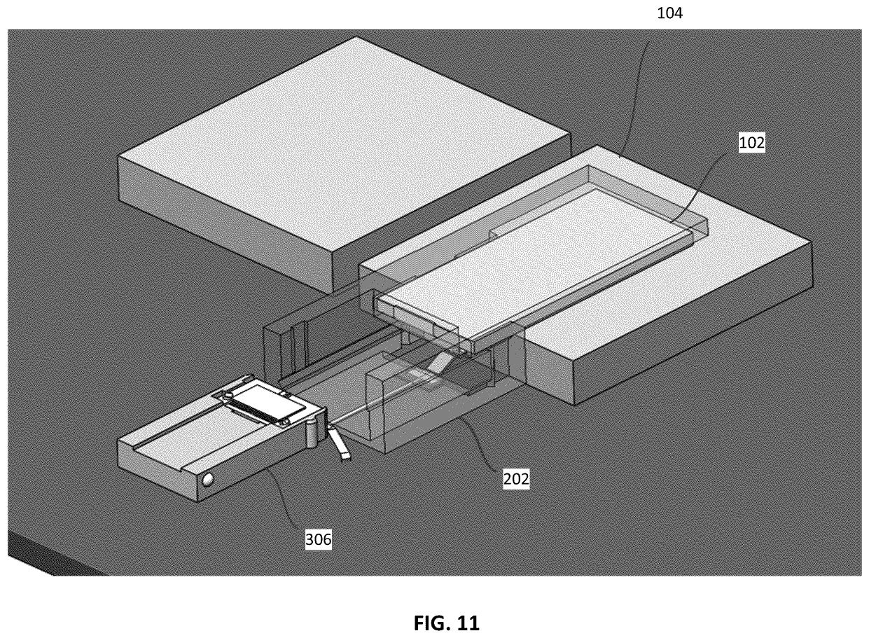

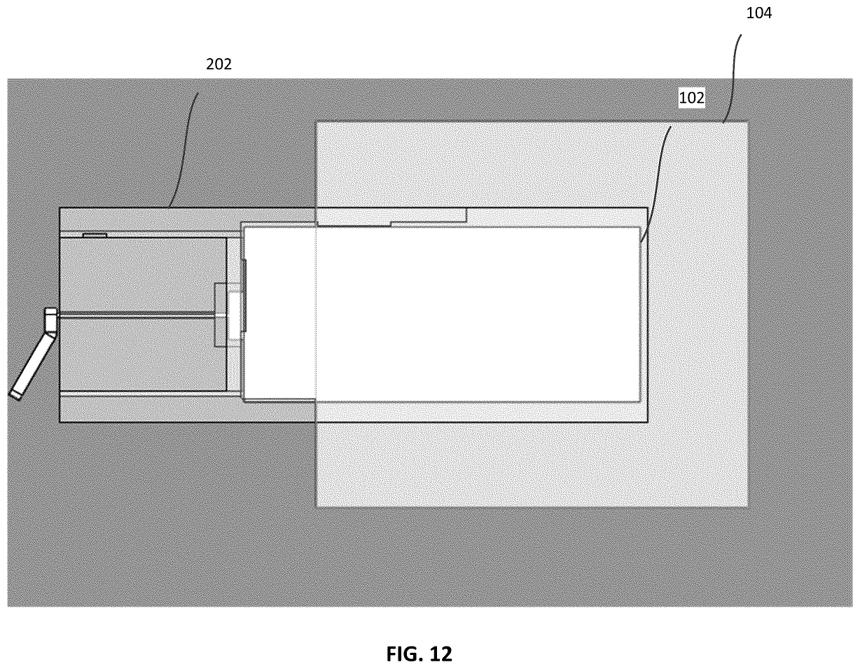

FIG. 10 depicts a top through-view of an example receptacle, an underlying PIC, and package substrate according to one or more aspects of the present disclosure. FIG. 11 depicts a through-view of an example receptacle, an underlying PIC, and uninstalled plug assembly 306 according to one or more aspects of the present disclosure. FIG. 12 depicts a top through-view of an example receptacle and underlying PIC and package substrate according to one or more aspects of the present disclosure.

Other arrangements and configurations of the detachable connectors 300 are considered and disclosed herein. FIG. 13 depicts an example receptacle 202 and uninstalled plug assembly 306 according to one or more aspects of the present disclosure. FIG. 14A depicts an example exploded plug assembly 306 according to one or more aspects of the present disclosure. FIG. 14B depicts an example plug cover with an example photonic plug 108 and fine alignment features. Referring to FIGS. 14A and 14B, the plug assembly 306 may comprise a photonic plug 108. The plug assembly 306 may house the photonic plug 108. The plug assembly 306 may assist in coarse and fine alignment of the photonic plug 108 and optical components (e.g., optical fibers 502) attached thereto, with the optical components of the PIC 102.

Referring to FIG. 14B, the plug assembly 306 may further comprise a plug cover 526. The photonic plug 108 may be connected to and/or housed in the plug cover 526. The photonic plug 108 may be connected to the plug cover 526 in one or more of a number of manners. For example, the photonic plug 108 may be clamped in place with the assistance of a plug base 1402 (described below). Additionally or alternatively, the plug cover 526 may be over-molded (e.g., over the photonic plug 108) in a low-temperature compound (e.g., polyamide). The optical components (e.g., optical fibers 502) may be attached to the photonic plug 108 before the attachment of the photonic plug 108 with the plug cover 526 or after the attachment of the photonic plug 108 with the plug cover 526. Additionally or alternatively, the photonic plug 108 may be bonded to the plug cover 526, for example, via an adhesive and/or epoxy. The plug cover 526 may comprise coarse and/or fine alignment features (e.g., similar to alignment features elsewhere herein). For example, the plug cover 526 may comprise plug cover spheres 1408 (e.g., the plug cover spheres 1408 may be substantially similar to the spheres 304 described herein), and the photonic plug 108 may comprise plug cover mating v-grooves 1410 (e.g., the plug cover mating v-grooves may be substantially similar to the v-grooves 302 described herein). The engagement of the plug cover spheres 1408 with the plug cover mating v-grooves 1410 may facilitate fine alignment of the photonic plug 108 in the plug cover 526. The fine alignment features of the plug cover 526 and the photonic plug 108 may be fabricated during the fabrication of the underlying part, ensuring accurate placement of the fine alignment features. Additionally, the plug cover 526 may comprise a void to receive the photonic plug 108. The void may be shaped to provide coarse alignment of the photonic plug 108 within the plug cover 526 and plug assembly 306.

Referring to FIG. 14A, one or more sides of the plug cover 526 may comprise one or more observation/installation holes 516 (e.g., in a portion above and/or to the side of the photonic plug 108 and/or one or more of the photonic plug 108 edges). The one or more observation/installation holes 516 may provide certain advantages. For example, following the installation of the photonic plug 108 in the plug assembly 306 and or plug cover 526, the observation/installation holes 516 may be used to confirm the proper alignment of the photonic plug 108 within the plug assembly 306 and/or plug cover 526. Fine alignments may be checked, adjusted, and/or executed via the observation/installation holes 516 as well. Additionally, the observation/installation holes 516 may be used for observation and alignment following the installation of the plug assembly 306 in the socket 204. Following the placement and alignment of the photonic plug 108 within the plug cover 526, adhesive and/or epoxy may be flowed into the observation/installation holes 516 to retain the photonic plug 108 in the plug cover 526.

The plug assembly 306 may further comprise a plug base 1402. The plug base 1402 may assist in retaining the photonic plug 108 within the plug assembly 306 (e.g., within the plug cover 526). The plug base 1402 may comprise coarse and/or fine alignment features to assist alignment of the photonic plug 108 and/or optical components attached to the photonic plug 108 (e.g., optical fibers 502) within the plug assembly 306. The plug base 1402 may be permanently or removably connected with the plug cover 526. For example, the plug cover 526 (and/or the plug base 1402) may comprise latch protrusions 1404. The plug base 1402 (and/or the plug cover) may comprise complementary latches 1406. If the plug base 1402 and plug cover 526 are installed together, the latches 1406 may be deformed around the latch protrusions 1404 during installation. The latches 1406 may comprise cutouts to accept the latch protrusions 1404. Upon installation, the cutouts may accept the latch protrusions 1404, and the latches 1406 may snap back toward their undeformed state. Thereby, the latches 1406 and latch protrusions 1404 may hold the plug base 1402 and plug cover 526 in place. Other methods of plug base 1402 and plug cover 526 attachment are contemplated. For example, the plug base 1402 and plug cover 526 may be magnetized together, clamped together, screwed together, adhered together (e.g., via an adhesive or other bonding agent), etc. Alternatively, the plug base 1402 and plug cover 526 may comprise a unitary part.

FIG. 16 depicts an example plug assembly 306 according to one or more aspects of the present disclosure. Referring to FIG. 16, the plug base 1402 and/or the plug cover 526 may comprise optical component retention features. For example, the optical components connected to the photonic plug 108 may comprise optical fibers 502. The plug base 1402 and/or the plug cover 526 may comprise rubber grommets 1412. Upon installation of the plug base 1402 with the plug cover 526, the rubber grommets 1412 may sandwich the optical fibers 502. Such features may provide strain relief of the optical fibers 502 and may assist in retaining the optical fibers 502 such that movement of the optical fibers 502 is minimized after installation. This may be advantageous to ensure that the fine alignment of the photonic plug 108 within the photonic cover (for example, via spheres/semi-spheres and v-grooves as described below) is not disturbed with a force to the optical fibers 502 (for example, if the optical fibers are bumped).

Referring to FIG. 14A, while the plug assembly 306 is described as comprising three parts, each of the described parts may be further subdivided. Additionally or alternatively, multiple described parts may be joined. For example, the plug cover 526 and photonic plug 108 may comprise a single part (e.g., silicon die, a metal substrate, etc.) additionally or alternatively, the plug assembly 306 may comprise a single unified part.

Referring again to FIG. 13, the receptacle 202 may be attached to (e.g., bonded to) the top side of the PIC 102. Additionally or alternatively, the receptacle 202 may be attached to the package substrate 104 and/or the main board 106 (e.g., as described herein above with reference to FIGS. 2A-2C).

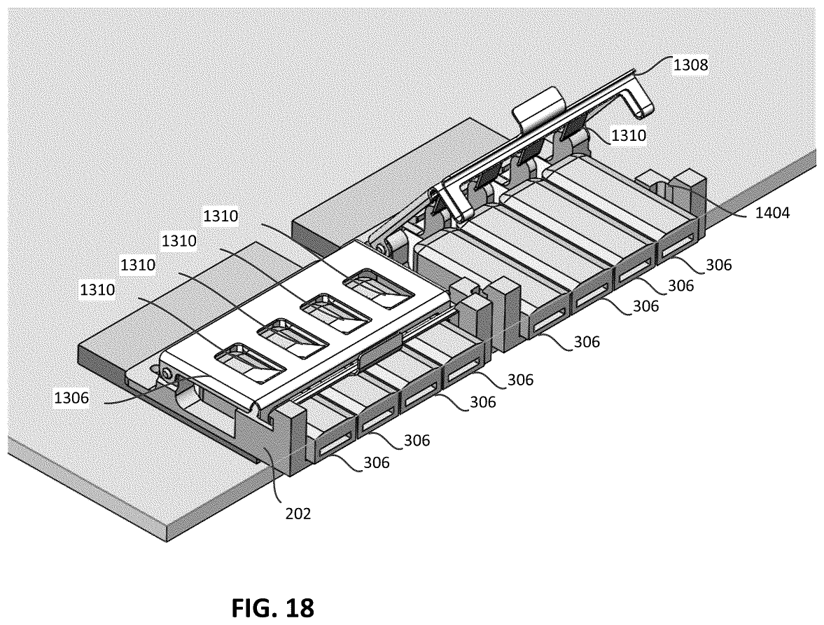

The receptacle 202 may comprise a socket 204. The socket 204 may be configured to receive and/or align one or more plug assemblies installed (e.g., seated) therein. The socket 204 may be connected to the PIC 102. Additionally or alternatively, the socket 204 may be connected to the PIC 102, the package substrate 104, and/or the main board 106 (e.g., to which the PIC 102 may be connected or to which the package substrate (to which the PIC 102 may be connected) may be connected). The socket 204 may further be configured to align an optical component connected to the plug assembly 306 with the PIC terminus components 209 to facilitate an optical connection between the PIC 102 and the optical component (e.g., optical fibers 502). The socket 204 may be further configured to provide coarse and/or fine alignment of the plug assembly 306 and/or the optical components attached thereto, with the terminus components 209 of the PIC 102. FIG. 13 depicts a single socket 204 receptacle 202; however, receptacles 202 may comprise any number of sockets 204 to receive any number of plug assemblies 306 (see, e.g., FIG. 18).

The receptacle 202 may be connected to the PIC 102 and/or the main board below the PIC (e.g., to which the PIC is also connected) in any number of ways. For example, the socket 204 may be bonded to the main board. The socket 204 may be bonded to the main board, for example, via one or more structural adhesives (e.g., epoxy resin, paste, etc.). The receptacle 202 may be connected to the main board in any number of other ways. For example, the receptacle 202 may be: clipped to the main board (for example, using mechanically complementary components), clamped to the main board, soldered to the main board, magnetized in place in relation to the main board, etc. The receptacle 202 may comprise one or more observation/installation holes 208 in which adhesive may be applied once the receptacle 202 is placed and positioned on the main board, PIC 102, and/or package substrate 104. Accordingly, fine alignment of the receptacle 202 with respect to the PIC terminus components 209 may be achieved. Following fine alignment (and, e.g., adjustment), the receptacle 202 may be held in place, and adhesive may be applied in the observation/installation holes 208 of the receptacle 202. The receptacle 202 may be connected to any or all of the main board, the PIC, and/or the package substrate. The connection method of the receptacle to an underlying substrate may be any of the methods of connection described herein.

The receptacle 202 may be configured to assist heat dissipation from the PIC 102, package substrate, and/or main board (e.g., as a heat sink). Accordingly, the receptacle 202 may comprise features to improve its heat-sinking capability (e.g., heat sink fins of any nature). Additionally, the portion of the receptacle 202 attached to the main board (e.g., the socket 204) may comprise a material with relatively high thermal conductivity (e.g., copper, aluminum, other metals, etc.). A thermal paste may be used between the receptacle 202 and the PIC 102 and/or between the receptacle 202 and the main board and/or the package substrate 104 to further improve the heat sink features of the receptacle 202. The thermal paste may be used alone and/or in conjunction with adhesives. The receptacle 202 may comprise one or more materials (e.g., metal or metal and plastic). For example, the portion adjacent to the PIC may comprise one material (e.g., metal), while the clip portion (described below) may comprise other materials. Accordingly, the receptacle 202 may be produced via one or more methods of production. For example, in the case of an all or partially metal receptacle 202, the metal portions may be CNC machined, stamped, molded, 3D printed, etc. In the case of an all or partial polymer receptacle 202, the polymer portions may be, for example, injection molded, 3D printed, etc. The receptacle 202 may comprise a cutout to accept the PIC 102. The cutout may be configured to align the PIC 102 with respect to the receptacle 202 and to the ultimately installed plug assembly 306.

The socket 204 may comprise coarse alignment components. According to some configurations, coarse alignment may comprise about +−100 micrometers. According to alternative configurations, coarse alignment may be substantially more or less than 100 micrometers. The socket 204 may comprise one or more plug guides 1302. The plug guides 1302 may be configured to guide the plug assembly 306 as the plug assembly 306 is being installed in (e.g., lowered into) the socket 204. Additionally, the plug guides 1302 may be configured to reduce movement (e.g., lateral and or longitudinal movement) of the plug assembly 306 if the plug assembly 306 is installed in the receptacle 202. Similar to the latch protrusions 1404 of the plug cover 526, receptacle protrusions 1304 may retain the socket cover 1306 (as described below).

The receptacle 202 may further comprise a socket cover 1306. The socket cover 1306 may be rotatably mated to the socket 204 (for example, via hinge 1312). Additionally or alternatively, the socket cover 1306 may be slidably mated with the socket 204. Accordingly, if the plug assembly 306 is seated in the socket 204, the socket cover 1306 may be moved toward and away from the plug assembly. The socket cover 1306 moved toward the socket 204 may close and secure the plug assembly 306 within the socket 204. The socket cover 1306 may be retained (in various manners) in a closed state (e.g., retained to the socket 204 and/or in relation to the socket 204).

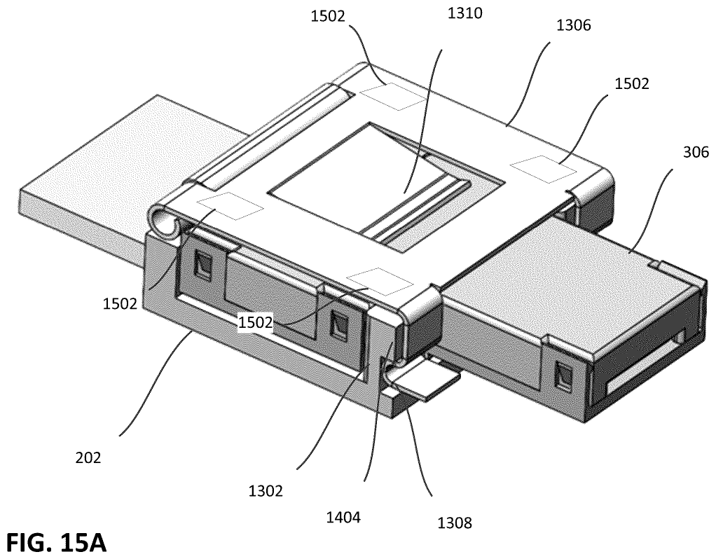

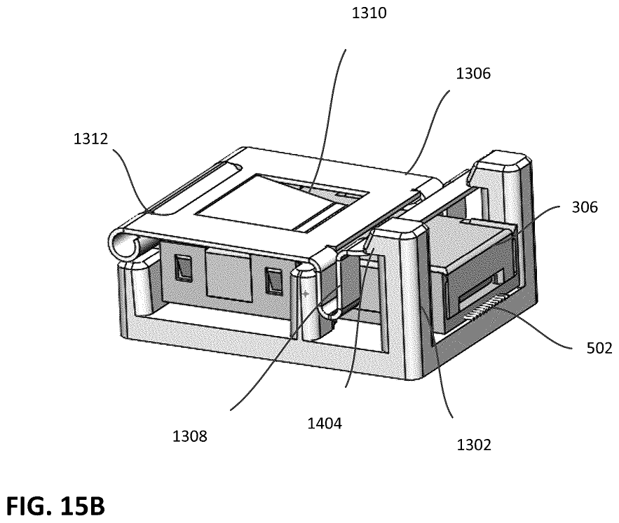

FIGS. 15A-15B, depict example plug assemblies 306 and example receptacles 202 in an example closed and installed state according to one or more aspects of the present disclosure. Referring to FIGS. 15A and 15B, receptacle 202 may comprise one or more latch protrusions 1304. The socket cover 1306 may comprise one or more latch features 1308 that may correspond to the latch protrusions 1304. The latch protrusions 1404 may be disposed anywhere on the receptacle 202. For example, the latch protrusions 1404 may be incorporated into one or more of the plug guides 1302. The latch protrusions 1304 may be on any side of the plug guides 1302. As the socket cover 1306 is closed toward the socket 204, the latch protrusions 1304 may deform the socket cover latch features 1308; for example, pushing the socket cover latch features 1308 from their natural resting position. As the socket cover 1306 is further installed, the socket cover latch features 1308 may clear the latch protrusions 1304. As they clear the latch protrusions 1304, the socket cover latch features 1308 may return towards their natural state, thereby engaging the latching features 1308 and the latch protrusions 1304 to retain the socket cover 1306 in place. In order to open the socket cover 1306, the socket cover latch features 1308 may be pulled away from (or, depending on configuration, pushed away from) their resting place to clear the latch protrusions 1304 of the plug guides 1302. Thereby, the socket cover 1306 may be opened.

Similar to the observation/installation holes 516 described above with respect to the plug assembly 306 cover, the socket cover 1306 may additionally comprise one or more socket cover observation/installation holes 1502. The socket cover observation/installation holes 1502 may comprise strategically placed cutouts and/or voids in the socket cover 1306. Using the socket cover observation/installation holes 1502, following the installation of the plug assembly 306 within the socket 204, the alignment of the plug assembly 306 (and the photonic plug 108, e.g., through the observation/installation holes 516 in the plug cover 526) may be confirmed and/or adjusted.

Referring again to FIG. 13, the socket cover 1306 may further comprise a latch cover spring 1310. The latch cover spring 1310 may be configured such that upon plug assembly 306 installation and socket cover 1306 closure, the latch cover spring 1310 may assert a force on the plug assembly 306. The force may push the plug assembly 306 toward the PIC 102. The latch cover spring 1310 may work in conjunction with the socket cover latch features 1308 (and latch protrusions 1304) to provide the downforce on the plug assembly 306. The force of the latch cover spring 1310 may be adjusted as desired. It would be understood by those of ordinary skill in the art to adjust the latch cover spring 1310 stiffness to provide the desired downforce on the plug assembly 306. The stiffness of the latch cover spring 1310 may further be adjusted to allow for holding the plug assembly 306 in place while also ensuring the mating surfaces (e.g., the mating surfaces of the PIC 308 and/or the mating surface of the photonic plug 310) and alignment features (e.g., spheres 304 and v-grooves 302) are not damaged by the force. Example forces applied by the latch cover spring 1310 may comprise, for example, less than 5N, about 5N, about ION, or more. Persons of ordinary skill will be able to determine the optimal latch cover spring 1310 force according to the materials used in the plug assembly, the receptacle 202, the photonic plug 108, and the PIC 102. Additionally, the stiffness of the latch cover spring 1310 may be adjusted to securely hold the latch features 1308 in place (e.g., to reduce play in the socket cover 1306). Thus, the latch cover spring 1310 stiffness and the surrounding receptacle 202 structure may be balanced to apply a desired force to the plug as well as a desired force to reduce play in the socket cover 1306.

As described above, the PIC side (e.g., the PIC 102) and/or the plug assembly side (e.g., the photonic plug 108) may further comprise fine alignment features. For example, the PIC 102 may comprise fine alignment spheres 304, and photonic plug 108 may comprise v-grooves (e.g., v-grooves 302). The spheres 304 of the PIC side may align with the v-grooves 302 of the plug side. In the installed and seated position, the latch cover spring 1310 may engage a surface of the plug assembly 306, pushing the plug assembly 306 toward the PIC 102. The v-grooves 302 of the plug assembly 306 may engage the spheres 304 of the PIC 102 to assist in fine alignment between the plug assembly 306 and the PIC 102. Although the spheres 304 are depicted as being disposed on the PIC 102, the spheres 304 can be disposed elsewhere (e.g., a surface of the receptacle 202 (e.g., a surface of the socket 204). The fine alignment features may be configured differently; for example, rod-shaped alignment features may be used alternatively to or in addition to the spheres. Other complementary fine alignment features between the PIC 102 and the plug assembly 306 are contemplated herein.

Upon installation of the plug assembly 306 within the receptacle 202, the latch cover spring 1310 force of the socket cover 1306 may push on the plug assembly 306 and force the fine alignment features of the PIC and the photonic plug 108 to mate, resulting in fine alignment of the optical components of the plug assembly 306 and the optical components of the PIC.

The plug assembly 306 may be additionally or alternatively retained within the receptacle 202. For example, the underside of the plug assembly 306 may comprise magnets and or magnetically attractive material. Similarly, the top side of the socket 204 may comprise magnets and or magnetically attractive material. Accordingly, if the plug assembly 306 is installed within the receptacle 202, the magnetic force between the plug assembly 306 and the receptacle 202 may be operable to retain the plug assembly 306 within the socket 204. Additionally, the magnetic features may be configured to provide sufficient force to engage the fine alignment features of the photonic plug 108 and the PIC 102, as described above.

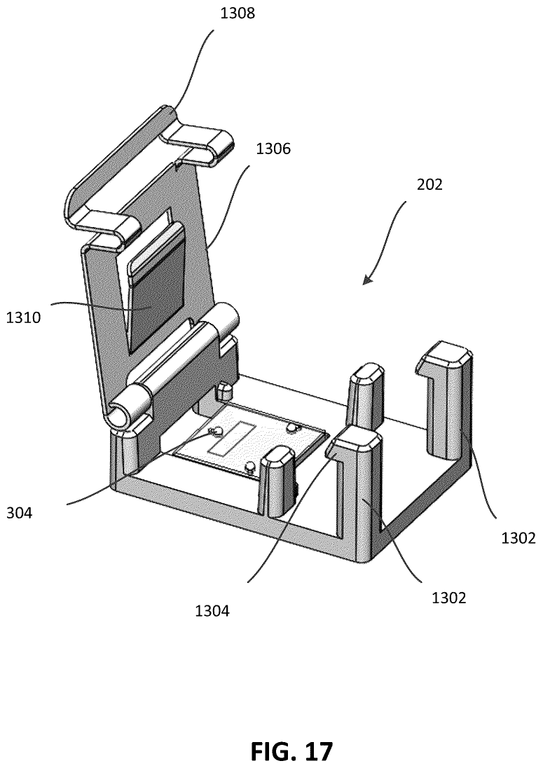

FIG. 17 depicts an example open receptacle 202 without a plug assembly according to one or more aspects of the present disclosure.

FIG. 18 depicts an alternative configuration of detachable connectors according to one or more aspects of the present disclosure. FIGS. 13 and 17 depicts single socket 204 receptacles 202 (e.g., receptacles configured to receive a single plug assembly 306). Receptacles 202 may be configured to receive any number of plug assemblies 306. Referring to FIG. 18, each receptacle may be configured to receive and mate to one or more PICs 102, a plurality of plug assemblies 306. The plurality of plug assemblies 306 may be retained via one or more socket covers 1306. The one or more socket covers 1306 may comprise one or more socket cover springs 1310. For example, the receptacle 202 may comprise a dedicated socket cover spring 1310 for each plug assembly 306. Alternatively, the receptacle 202 may comprise a socket cover spring 1310 for a grouping of plug assemblies 306 (e.g., one socket cover spring 1310 for two plug assemblies).

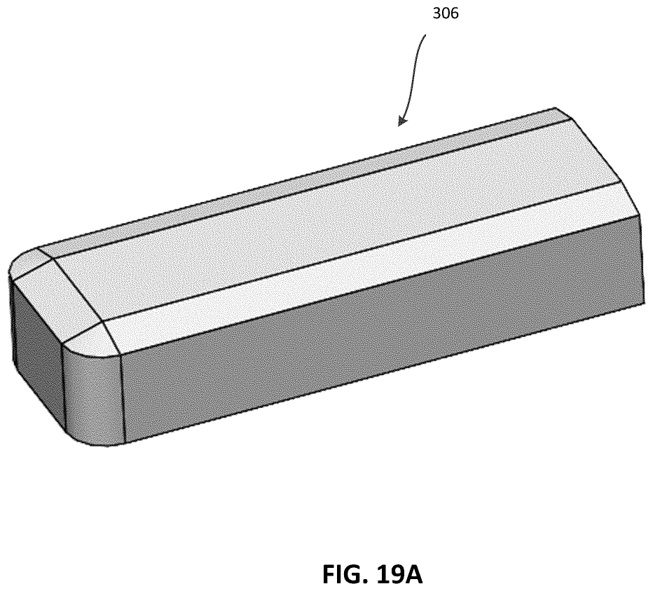

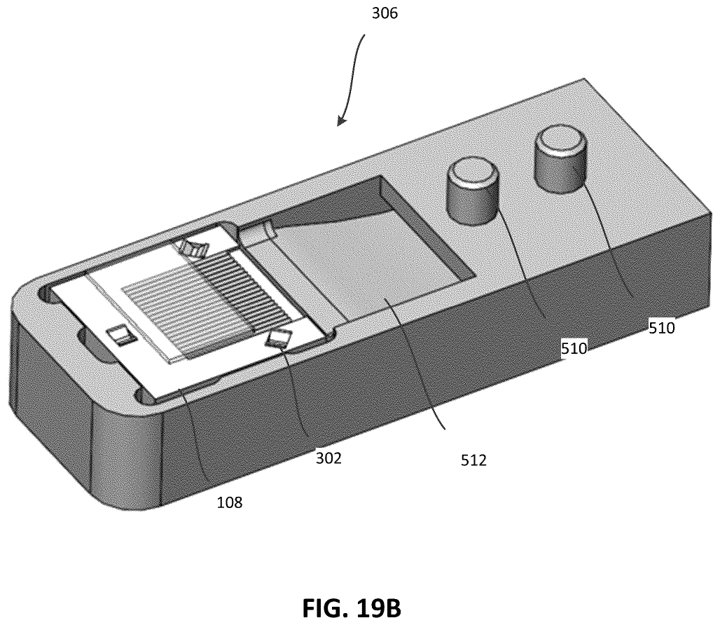

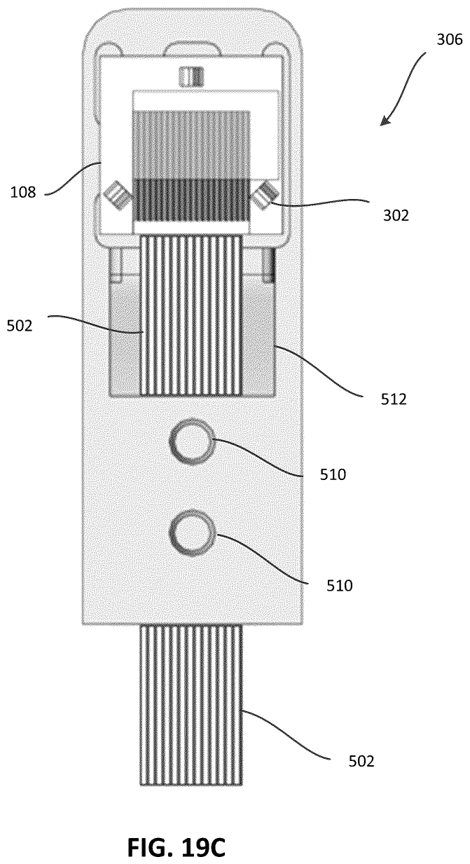

FIGS. 19A-19C depict various views of an example alternatively configured plug assembly 306 according to one or more aspects of the present disclosure. The plug assemblies 306 may be variously shaped. Referring to FIG. 19B, the alignment protrusions 510 may be on a bottom surface of the plug assembly 306 (e.g., in addition to or as opposed to on a side surface). According to such a configuration, the receptacle 202 may comprise one or more protrusion-accepting sockets. The protrusions 510 may plug into the protrusion-accepting socket of the receptacle 202. Thereby, the plug assembly 306 may be coarsely aligned within the receptacle 202.

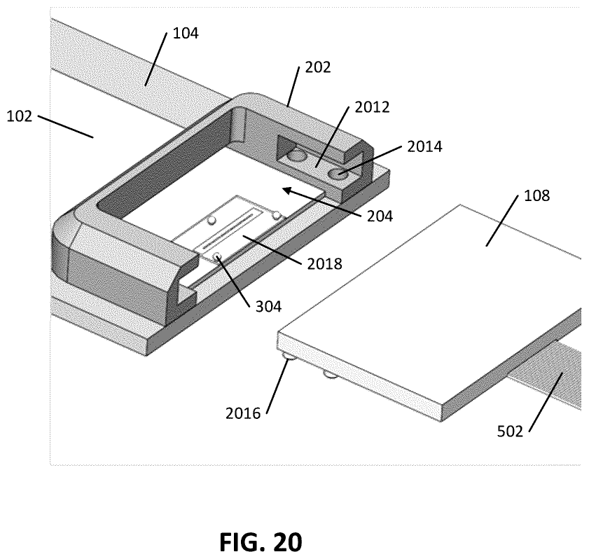

FIG. 20 depicts a through-view of an example receptacle and plug assembly according to one or more aspects of the present disclosure. The photonic plug 108 may be mated with the receptacle 202 for optical coupling. Rough alignment features and fine alignment features described herein may help guarantee accurate placement between the photonic plug 108 and the receptacle 202. Rough alignment may be provided by mechanical elements such as guiding rail 2012 established during horizontal (e.g. lateral) insertion of the photonic plug 108 inside the socket 204 (e.g., into the guiding rail 2012). Fine alignment may be provided by incorporating features on either or both of the photonic plug 108 and PIC 102, as further described herein. The photonic plug 108 may comprise one or more bars 2016 (e.g., pins, protrusions, etc.) protruding from the bottom side. The one or more bars 2016 may be configured to fit into one or more corresponding holes 2014 of the receptacle 202. The one or more bars 2016 may be variously shaped, for example, cylindrical, cuboid shaped, etc. The one or more holes 2014 may be shaped to correspond to the one or more bars 2016. The ribbon 502 may be coupled to the photonic plug 108. The receptacle 202 may be coupled to the PIC 102 and/or the package substrate 104. Additionally or alternatively, the PIC 102 may be connected to the package substrate 104. The receptacle 202 may comprise socket 204, spheres 304, guiding rail 2012, holes 2014, and/or BoC (Bump on Carrier)/Glass die 2018. A BoC may comprise a photonic bump, examples of which may be found in commonly assigned U.S. patent application Ser. No. 17/989,303, the contents of which are incorporated herein by reference in their entirety, on a carrier substrate. For example, the photonic bump may comprise one or more curved mirrors, turning curved mirrors, etc., to facilitate optical connection optical fibers to the PIC 102. The photonic bump may be manufactured on the carrier. The BoC may also be referred to as a photonic bump. Additionally or alternatively, one or more features of a BoC described herein may be directly incorporated (e.g., fabricated on and/or with) the PIC 102.

Glass die 2018 on PIC 102 with fine alignment features may be a transparent optical medium with fine alignment mechanical features. Alternatively, the glass die 2018 on PIC 102 may be the BoC. Additionally, the glass die 2018 may include electrical bumps of pad. The electrical bumps may serve as electrical interposers besides optics and mechanics functions. Glass die 2018 on PIC 102 may be added based on die-to-wafer or die-to-die processes. The die-to-wafer and/or die-to-die processes may provide high accuracy. The glass die 2018 may be manufactured to withstand reflow processes of chip packaging methods. Glass die 2018 to PIC 102 attach may be performed via pick and placed tools based on alignment marks to assist placement accuracy of sub-micron to 10's of microns. The number of fine alignment features is at least three or more. The fine alignment features may assist both height control as well as tilt control.

The socket 204 may be made of one or more of various materials, for example, metal, plastic, glass, silicon, etc. The socket 204 may be manufactured, for example, by CNC or plastic mold/injection techniques. The material of the socket 204 may be configured such that it maintains and/or is compatible with photonic and electronic packaging processes including reflow temperature. In some configurations, the socket 204 may be placed and/or aligned within a few microns to few 10's of microns relative to the PIC 102. Pick and place die assembly techniques may be used for socket placement and attachment. The alignment and/or attachment may be established based on passive assembly, for example, via alignment marks placed on the socket 204 and/or the PIC 102. Also or alternatively, the alignment and/or attachment may be established by use of PIC diced edges to perform needed placement accuracy. The alignment marks may be placed based on wafer processes. Also or alternatively, alignment and/or attachment of the socket 204 relative to the PIC 102 may be established and or facilitated by mechanical alignment features, for example, correspondingly configured (e.g., protrusions and corresponding holes) mating features. The coupling and or retention of the socket 204 to the receptacle 202 may be provided and/or facilitated by adhesive or solder. The socket 204 may be placed on and or adhered to one or more of the PIC 102, the board (e.g., main board 106), and packaging substrate 104. The packaging substrate 104 may interface between the PIC 102 and the board and/or components connected and/or in communication with the board. The socket 204 may, also or alternatively, be placed on and/or secured to one or more of the PIC 102, the board, the packaging substrate 104, and other interfaces between PIC 102 and the board. Holes or other mechanical fixtures may be used to give the socket 204 further mechanical support, stability, and alignment (e.g., with the PIC 102).

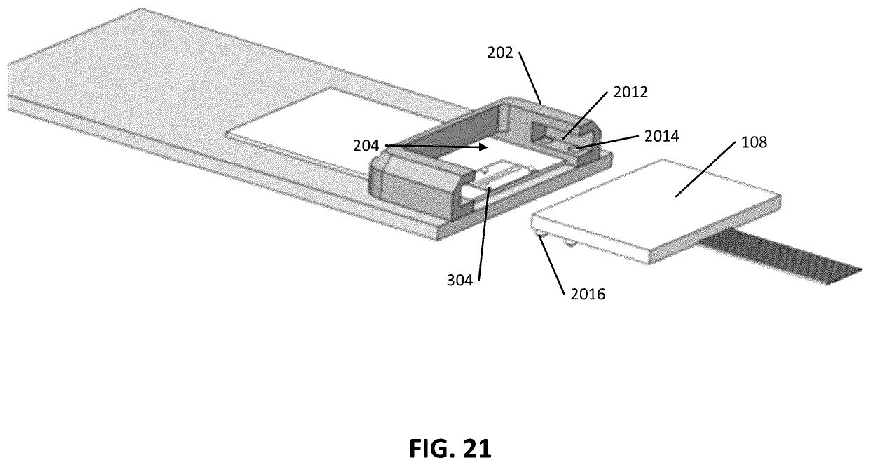

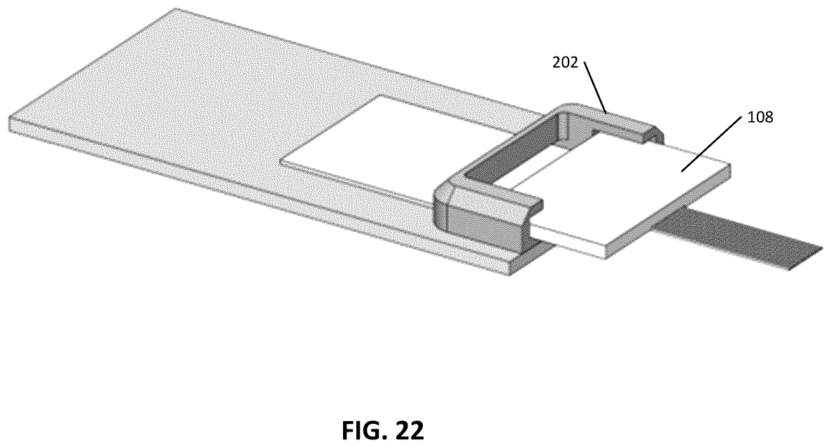

FIG. 21 depicts rough alignment features between receptacle and plug according to one or more aspects of the present disclosure. The detachable optical couplers described herein may use rough alignment and fine alignment (as further described herein) to facilitate connection of one or more various components. For example, referring to FIG. 21, rough alignment may be accomplished by mating of various elements and/or features of the plug 108 and one or more elements and/or features of the socket 204. The rough alignment features may facilitate and/or enable a horizontal movement (e.g., slide), for example a guided horizontal movement, of the plug 108 in relation to the receptacle 202. Also or alternatively, the rough alignment features may facilitate and/or enable a vertical movement (e.g., drop or downward shift) of the plug 108 in relation to the receptacle. In some configurations, the vertical movement may be enabled following the horizontal movement. For example, the plug 108 may be horizontally inserted into the socket 204 via the guiding rail 2012. Plug 108 may be pushed and/or slid into the guiding rail 2012 and/or pulled and/or slid out from the guiding rail 2012. If the plug 108 is slid into the guiding rail 2012 (e.g., fully or substantially fully slid into the guiding rail 2012), the plug 108 may move (e.g., drop and/or be dropped) vertically (e.g., downward) toward the PIC 102. The plug 108 may move vertically into further rough alignment by different mechanisms, as described herein. For example, the plug 108 may move vertically into rough alignment, for example, via gravity, springs, magnetic force, clips, and/or by other mechanisms (e.g., press mechanisms) for vertical movement, alignment, and/or retention. For example, cylindrical bars 2016 may be moved (e.g., dropped) into cylindrical holes 2014. The steps of horizontally sliding the plug 108 into the guiding rail 2012 and vertically dropping the cylindrical bars into the cylindrical holes 2014 may roughly align the plug (e.g., the optical components there attached and/or the mating surfaces (e.g., photonic plug mating surface 310)) with the PIC 102 (e.g., PIC mating surface (e.g., PIC mating surface 308). Rough alignment, in some configurations and examples, may be in the range of about 10's of microns to about ˜200 μm. As shown in FIG. 22, the plug 108 is mated with the socket 204.

FIG. 22 depicts the plug 108 installed in the receptacle 202. Following rough (e.g., coarse) alignment of the plug 108 and the PIC 102, the plug 108 and PIC 102 may be fine aligned (e.g., via fine alignment features, for example, substantially as described with respect to FIG. 3).

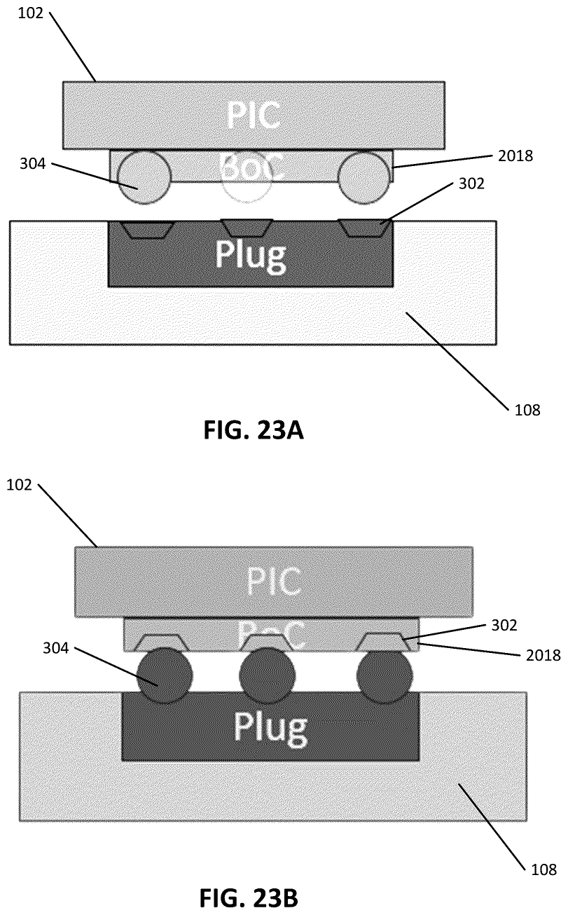

FIG. 23A and FIG. 23B show examples of fine alignment features. The fine alignment features described in relation to FIGS. 23A and 23B may be substantially similar to the fine alignment features described elsewhere herein (e.g., FIGS. 3, 5A, 5B, 8D, 13, 17, and 19C). Fine alignment features may comprise spheres (or semi-spheres) 304 and v-grooves 302. The fine alignment features may be built on geometry on the photonic plug 108 and/or the PIC 102 to be mated. These features may be fabricated in a way to assist placement accuracy and leveling (e.g., tilt, rotation, x-axis alignment, y-axis alignment, z-axis alignment), for example, of the plug 108 (and/or interface features of the plug) with the PIC 102 (and/or PIC interface features). The features of fine alignment may be fabricated on the plug 108 and or the PIC 102. The features for fine alignment may be fabricated, for example, via wafer level processes. Such process may facilitate accurate placement of the features and therefore, facilitate accurate placement and leveling (e.g., tilt, rotation, x-axis alignment, y-axis alignment, z-axis alignment) of components. Wafer level processes may include, for example, CMOS processes, wafer level optics, imprint technologies, lithography processes (e.g., gray-scale lithography) or combinations thereof. The shapes of these features may also differ. For example, spheres 304 may be replaced, for example, with substantially rod-shaped or conical shaped structures. Also or alternatively, v-grooves 302 may be replaced by substantially hemispheric, pyramidal, or rod-shaped voids.

Trench structures (e.g., v-grooves 302) on the photonic plug 108 may be mated with spheres 304 on the PIC 102. Additionally or alternatively, spheres 304 may be fabricated on the photonic plug 108 and may be mated with v-grooves on PIC 102. Other mechanisms and configurations may also be used as discussed herein. The spheres 304 and/or v-grooves 302 may be placed directly on the plug 108, PIC 102, or a die (e.g., glass substrate, silicon substrate, semiconductor substrate, etc.). The spheres 304 and/or v-grooves 302 may also or alternatively be attached to the plug 108 or PIC 102. Also or alternatively, the fine alignment features may be a combination of attached and/or fabricated on the plug 108 or PIC 102. The attaching may be established by, for example, adhesive solder bump techniques, etc.

As shown in FIGS. 23A-23B the spheres 304 and v-grooves may be configured variously and in various locations. FIG. 22A shows spheres 304 located (e.g., disposed) on BoC 2305 and v-grooves 302 located on the plug 108. All degrees of freedom (DOF) may be defined by three v-grooves 302 and three corresponding spheres 304. Although examples are depicted herein having three spheres 304 and three corresponding v-grooves 302, different examples and configurations may use more (e.g., four, five, six, etc.) or less (e.g., two) spheres 304 and corresponding v-grooves 302. The v-grooves may be etched on the plug 108. Alternatively, the v-grooves 302 may be deposited on the plug 108. Each of the spheres 304 may be located (e.g., disposed) in voids (e.g., via holes) in the BoC 2305. For glass BoC 2305 examples, the spheres 304 may be assembled and/or fabricated by, for example, Substrate Conformal Imprint Lithography (SCIL) or other glass fabrication techniques. The mechanics of the spheres 304 and v-grooves 302 may be similar to the pins and holes mechanics as discussed above. To improve friction between the spheres 304 (e.g., glass spheres) and the v-grooves 302, a surface finish (e.g., a low friction coating) may be applied to one or more of the spheres 304 and or v-grooves 302. In other examples or configurations, the spheres 304 and or v-grooves may comprise other materials. For example, the spheres 304 and/or v-grooves may be fabricated out of metal instead of glass. Such a configuration may improve friction between the sphere and v-groove surfaces.

While FIG. 23A depicts the spheres 304 incorporated with the BoC and the v-grooves 302 incorporated with the plug 108, the surfaces may be reversed. For example, referring to FIG. 23B, the spheres 304 may be incorporated with (e.g., disposed on, fabricated with and/or on) the plug 108, and the v-grooves 302 may be incorporated with (e.g., disposed on, fabricated with and/or on) the BoC 2305. The spheres 304 and v-grooves 302 may be fabricated and/or disposed on the plug 108 and BoC 2305, respectively, using the methods substantially as discussed above. Also or alternatively, the v-grooves 302 may be laser cut in the BoC 2305 (e.g., if the BoC is glass). The spheres 304 may be located on (e.g., disposed on), for example, via holes in the plug 108. Also or alternatively, the spheres may be located (e.g., disposed on, fabricated on) a glass cover on the plug 108. Although the v-grooves 302 and spheres 304 have been described in FIGS. 23A and 23B as being disposed on the BoC 2305, other configurations and examples may not include the BoC 2305. In such examples, the fine alignment features (e.g., spheres 304 and/or v-grooves 302) may be placed on (e.g., disposed on, fabricated in or on) the PIC 102.

Optical coupling between the plug 108 and PIC 102 may be established between optical fibers (e.g., fibers of ribbon 502) and PIC transceiver (e.g., laser, waveguide, waveguide and mirror, grating coupler, etc.) The structure of the coupling may support PICs 102 with grating coupler elements as well as PICs with wide-band surface coupling optics. Coupling may be performed between the plug 108 and PIC 102 through different interfaces. Such interfaces may include glass, air, silicon, or a combination thereof. Different optical designs may maintain light transmission through different optical media. Additionally or alternatively, coatings (e.g., anti-reflective coatings) on one or more different interface surfaces may be used, for example, to maintain desired indices of refraction between media interfaces. As an example, an air gap may be maintained between the plug 108 and a BoC/glass die (e.g., BoC/glass die 2018 of FIG. 20) disposed on the PIC 102. The air gap may be beneficial to obtain detachability functions. Also or alternatively, the air gap may be filled with liquid, for example, in configuration in which the chip package or system is immersed in liquid, for example for cooling purposes. The air gap or liquid gap may be maintained at a defined height from the PIC 102, for example, where the beam (e.g., light beam, signal beam) is expanded (e.g., to about tens of microns). Such configurations may also or alternatively be used to reduce beam coupling dust contamination, which may exist, for example in the environment (e.g., data center environment). The coupling/mating of the plug 108 and PIC 102 may also be utilized for PIC 102 with overhang geometry, for example, facing down and/or facing up, as well as coupling through backside of the PIC 102 (e.g., as described in commonly assigned U.S. patent application Ser. No. 17/989,303, the contents of which are incorporated herein by reference in their entirety.

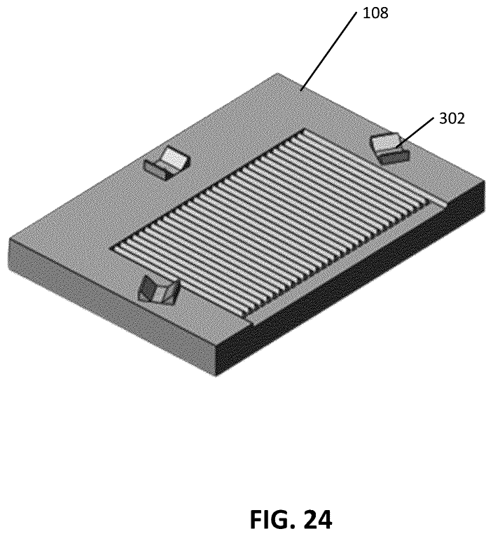

FIG. 24 depicts a bottom view of an example photonic plug 108 having three v-grooves 302 according to one or more aspects of the present disclosure. Photonic plug 108 may have three v-grooves 302 coupled to a surface of the plug 108. The v-grooves 302 may accept, engage, and/or fit around the spheres 304, for example, of FIGS. 23A-23B (and as described elsewhere herein).

As described herein, mechanisms and or forces may be incorporated that press and or force the plug 108 (e.g., down or up depending on orientation) toward the PIC 102 to perform vertical motion or support coupling engagement (e.g., of the fine alignment features). For example, magnets, springs, lock and release mechanisms, etc., may be used to secure a mating position between the plug 108 and the PIC 102 and to release if detaching. Such mechanisms and forces are described herein in more detail.

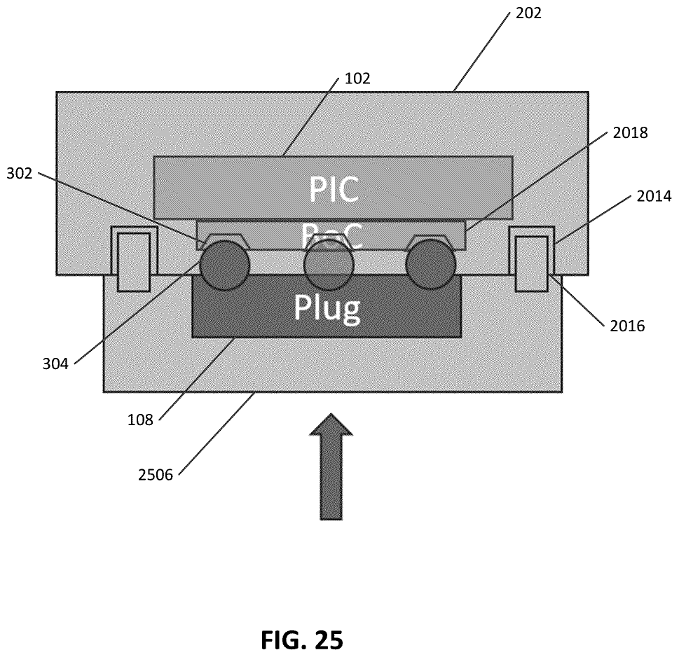

FIG. 25 depicts a receptacle 202 and plug 108 in a mated position according to one or more aspects of the present disclosure. Plug 108 may be housed in plug cover (e.g., substantially similar to plug cover 526 described herein) and together comprising plug assembly 2506. Also or alternatively, the plug cover and plug 108 may be combined into a single plug (e.g., a plug 108 that also incorporates the described features of the plug cover). Plug assembly 2506 may comprise bars/pins 2016 (e.g., substantially similar to bars 2016 of FIG. 20). Receptacle 202 may comprise holes 2014 (e.g., substantially similar to holes 2014 of FIG. 20). The plug 108 and/or plug assembly 2506 may be mated to the receptacle 202, for example, via the bars 2016 fitting into the corresponding and correspondingly configured holes 2014. Such a configuration may allow for the coupling to be maintained (e.g., locked) in position. The Z-axis coordinates, pitch-axis (0) coordinates and roll-axis (p) coordinates may be defined by the spheres 304 on the plug 108 (and/or on the BoC 2305 or PIC 102) engaged with the v-grooves 302 of the PIC 102 or BoC 2305 (or plug 108). The X-axis coordinates, Y-axis coordinates, and yaw-axis (W) coordinates may be defined by the coarse (e.g., rough) alignment mechanical features (e.g., the bars 2014 and holes 2014) on the plug 108 (and/or plug cover) and receptacle 202. These mechanical features may benefit from good lead-in angles, low friction, and sufficient clamping force. Accordingly, such elements may be considered when designing such features. For example, a pin in hole configuration may, in some examples, yield about a +/−25 μm positioning accuracy in X, Y and about 0.1 deg in ψ. This may be due to the socket 204 positioning over the PIC 102. The holes 2014 in the receptacle 202 may be adjusted in the assembly process, for example, using a master jib. Using such a technique, the positioning accuracy may be reduced, in some examples, to about +/−7-10 μm.

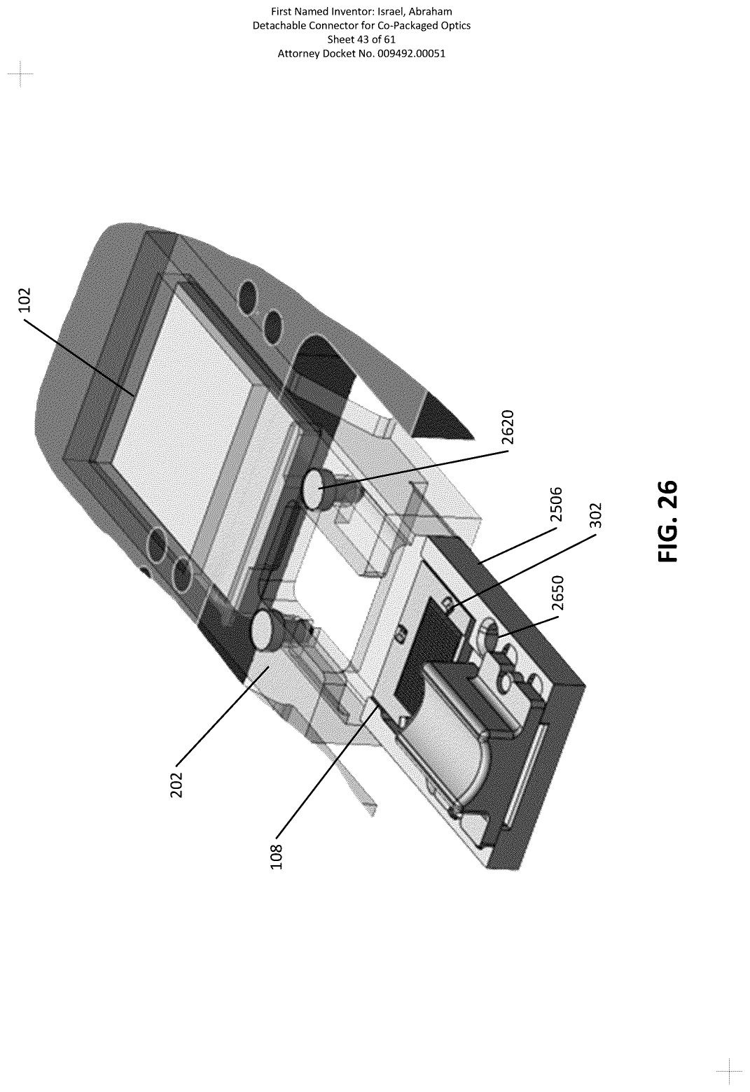

FIG. 26 depicts a receptacle with adjustable pins according to one or more aspects of the present disclosure. FIG. 26 shows an example of some of the features described in relation to FIG. 25. The receptacle 202 may comprise adjustable pins 2620 (e.g., similar to bars 2016 unless otherwise described herein). While FIG. 26 shows an example including two adjustable pins 2620, the receptacle 202 may include any number of adjustable pins 2620. The plug assembly 2506 may comprise holes 2650. The adjustable pins 2620 may be inserted into holes 2650, for example, after the plug assembly 2506 is inserted into the socket 204. The receptacle 202 may be assembled onto the PIC 102, for example, using pick and place methods and (including pick and place accuracy). Additionally or alternatively, the assembly (e.g., the PIC 102 and the receptacle 202) may be placed through a reflow process. Following reflow, the adjustable pins 2620 may be placed, aligned and bonded in place. The alignment and bonding may be performed by active alignment, for example, relative to the PIC 102 or passive alignment, for example, relative to a plug 108. The plug assembly 2506 may be slid horizontally into the receptacle 202. Following horizontal insertion, the plug assembly 2506 may be moved vertically, for example, towards the PIC 102 engaging the adjustable pins 2620 and the holes 2650. The sliding of the plug assembly 2506 into the receptacle 202 and the engagement of the pins 2620 and the holes 2650 may comprise and/or achieve rough alignment of the PIC 102 and the plug 108 as described herein. Further, the vertical movement of the plug 108 towards the PIC 102 may engage the v-grooves 302 with fine alignment features of the PIC 102 (e.g., spheres as described herein) (not shown) effecting fine alignment as described herein.

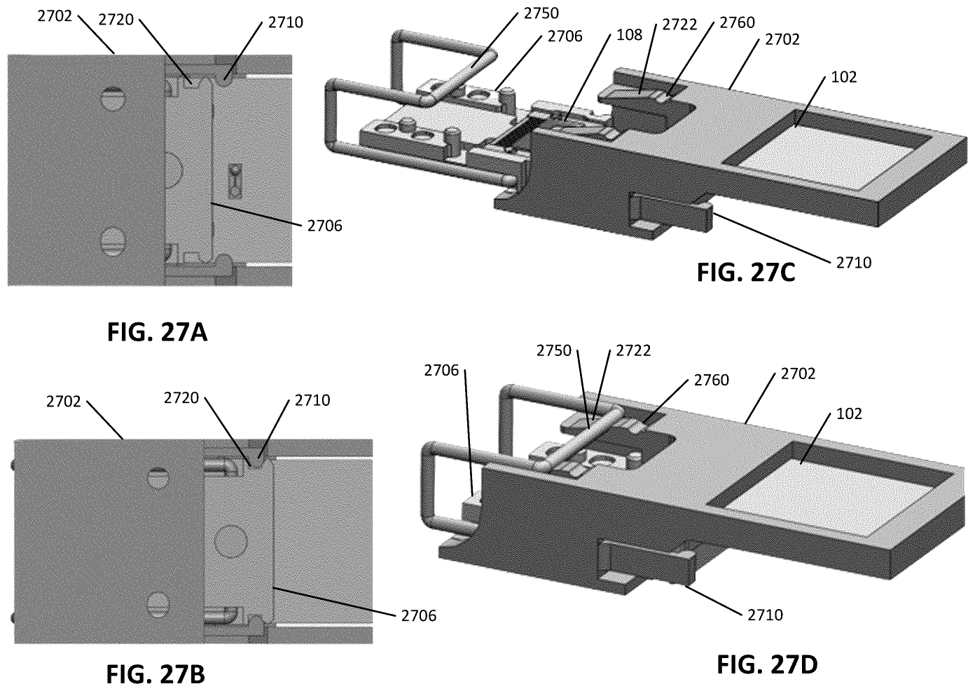

FIGS. 27A-27D depict various views of a locking mechanism according to one or more aspects of the present disclosure. FIG. 27A shows a bottom view of a plug assembly 2706 and receptacle 2702 during insertion. The plug assembly 2706 may comprise cutouts 2720. The cutouts may be configured to engage snap arms 2710 of the receptacle 2720 following insertion. FIG. 27B shows a bottom view of a plug assembly 2706 inserted into receptacle 2702. Referring to FIGS. 27A and 27B, during insertion of the plug assembly 2706 into the receptacle 2702, a lip of the cutout 2720 may be angled to force the snap arms 2710 to deform from their resting position. Following further insertion of the plug assembly 2706 into the receptacle 2702, the plug assembly may be slid further such that the snap arm 2710 clears the lip of the cutout 2720 and aligns with the cutout 2720. If the snap arm 2710 aligns with the cutout 2720, the snap arm 2710 may move toward its resting position. Snap arm protrusions 2710 may be configured to engage and or fit into the cutouts 2720. Accordingly, the cutouts 2720 may retain (e.g., lock) the snap arms 2710 in place as shown in FIG. 27B. The engagement of the cutouts 2720 and the lock arms 2710 may cause resistance to relative horizontal (e.g., sliding) movement of the plug assembly 2706 in relation to the receptacle 2702.

FIG. 27C shows a top view of an example plug assembly 2706 and receptacle 2702 during insertion. The plug assembly 2706 may comprise a wire spring 2750. The receptacle may comprise one or more inclined surfaces 2722 (e.g., ramp). FIG. 27D shows a top view of the example plug 2706 being inserted into receptacle 2702. Referring to FIG. 27D, the one or more inclined surfaces 2722 may be configured to engage the wire spring 2750 as the plug assembly is slid into the receptacle 2702. The engagement of the wire spring 2750 and the one or more inclined surfaces 2722 may draw the plug assembly 2706 (and in turn, the plug 108) toward the PIC 102 as the plug assembly 2706 is slid further into the receptacle. The one or more inclined surfaces 2722 may terminate (e.g., at an end of the one or more inclined surfaces 2722) in a groove 2760 configured to engage and retain the wire spring 2750. For example, upon substantially complete insertion of the plug assembly 2706 into the receptacle 2702, the wire spring 2750 may snap into grooves 2760. The wire spring 2750 may be positioned and retained (e.g., locked) in place once mated with the grooves 2760. For example, mating of the wire spring 2750 with the grooves may retain the plug assembly 2706 in the desired vertical position in relation to the PIC 102. Further, the wire spring 2750 holding the plug assembly 2706 in vertical relation to the PIC 102 may maintain the engagement of the fine alignment features (e.g., spheres and v-grooves) of the plug 108 and the PIC (and/or BoC) as described herein. Also or alternatively, engagement of the wire spring 2750 and the groove 2760 may further resist the relative horizontal movement of the plug assembly 2706 and the receptacle 2702.

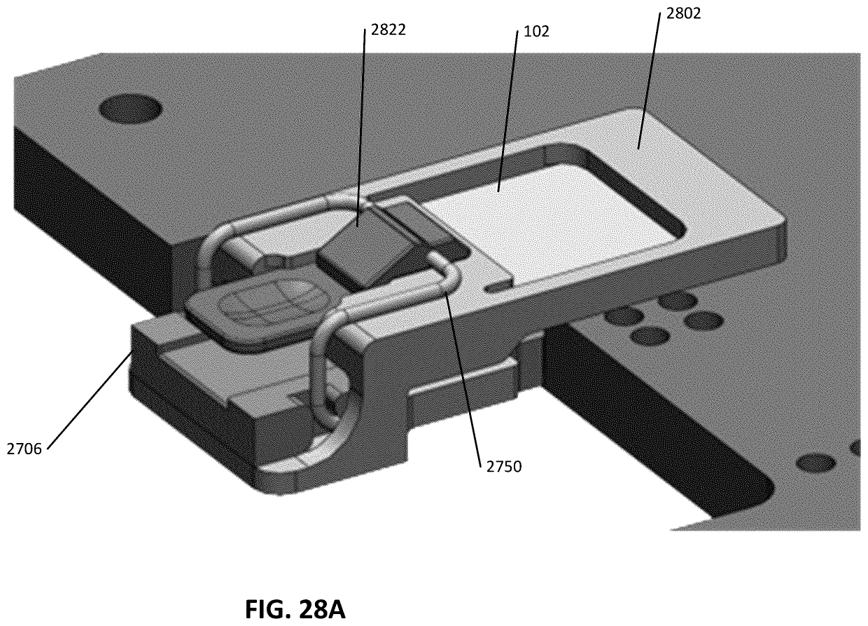

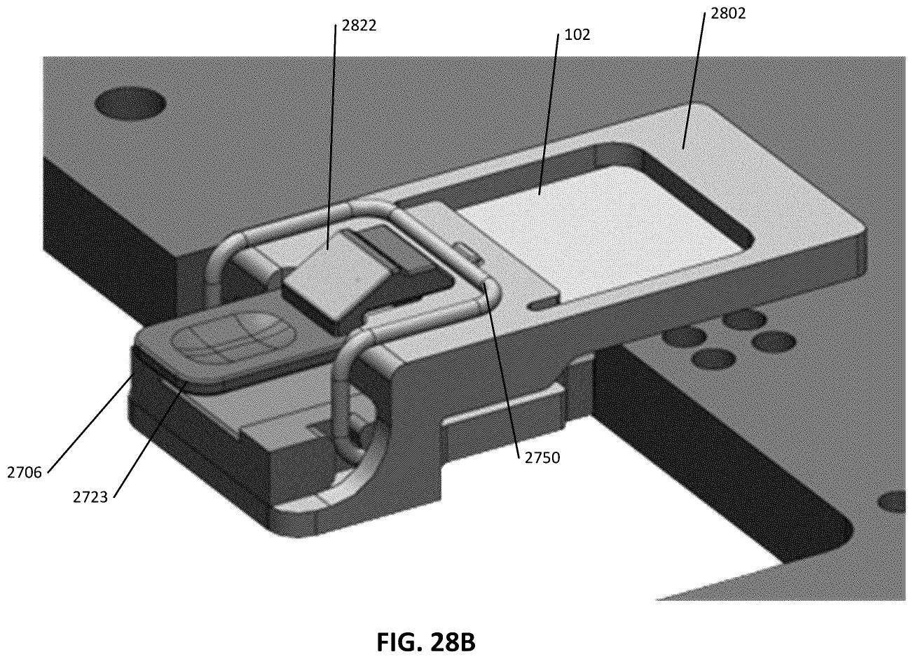

FIGS. 28A-28B depict an alternative example retention mechanism according to one or more aspects of the present disclosure. FIG. 28A shows a plug assembly 2706 and receptacle 2802 in an engaged position. Similar to features described with respect to FIGS. 27C-27D, the receptacle 2802 may comprise one or more inclined surfaces 2822 (e.g., to draw and retain plug assembly toward the PIC 102 as described in relation to FIGS. 27C-27D. The one or more inclined surfaces of FIGS. 27C-27D are depicted as fixed. However, referring to FIGS. 28A and 28B, the one or more inclined surfaces 2822 may be moveable (e.g., deflectable, rotatable, pivotable, slideable, etc.). Also or alternatively, the inclined surface 2822 (e.g., ramp) may be spring loaded (e.g., prejudiced toward a natural resting position). For example, the one or more inclined surfaces may be moveable to enable improved engagement (e.g., mounting, installation, etc.) and dismounting (e.g., extraction) of the plug assembly 2706 and the receptacle 2702 (e.g., with a reduced chance of damaging features of the plug and or PIC 102 (e.g., fine alignment features)). For example, FIG. 28B shows plug assembly 2706 and receptacle 2802 in an extraction position. In FIG. 28A, the inclined surface 2822 may be preloaded (and/or biased towards its resting position) and retains (e.g., locks) the wire spring 2750 in place (e.g., substantially as described with respect to FIGS. 27A and 27B). Referring to FIG. 28B, the inclined surface 2822 may be moved (e.g., pulled back, slid, rotated, etc.) from its resting position to release the wire spring 2750. Accordingly, with the wire spring 2750 released, the plug assembly may move vertically (e.g., drop) from its installed position, and the fine alignment features (and/or rough alignment features) may be disengaged. Further, the plug assembly may be removed horizontally (e.g., slid) from the receptacle 2802 with a reduced increased ease and a reduced chance of damaging mating surfaces. Similarly, the inclined surface 2822 may be moved from its resting position during installation similarly reducing improving ease of installation, and reducing the chance of stress and or damage to mating surfaces during installation. The inclined surface 2822 may be allowed to reform back to its resting position, for example, following insertion of the plug assembly into the receptacle 2802 such that the plug assembly is drawn toward, and retained in relation to, the PIC 102. The inclined surface 1822 may be connected to a lever arm 2723. A force on the lever arm may be transferred to the inclined surface 2822 to move (e.g., deflect, slide, pivot, etc.) the inclined surface 2822 from its resting position (e.g., its resting spring-loaded position). In an alternative example, the inclined surface 2822 may be pushed forward (instead of pulled) to release the wire spring 2750.

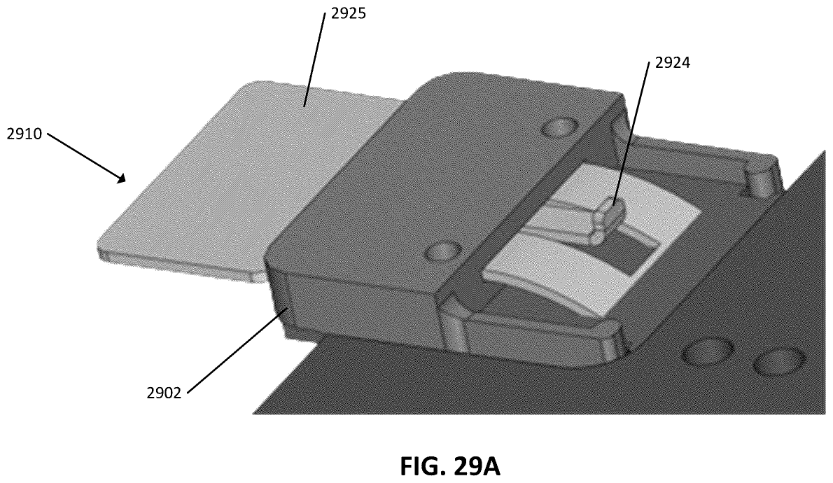

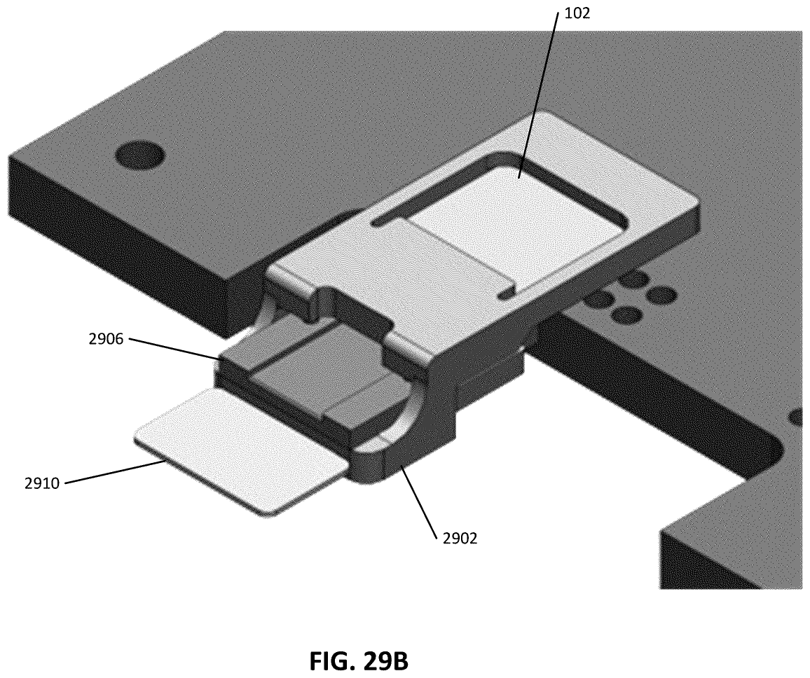

FIGS. 29A-29B depict a top view and bottom view of an example leaf spring retention mechanism according to one or more aspects of the present disclosure. FIG. 29A shows a bottom view of a receptacle 2902 comprising a leaf spring 2910 retention mechanism. The leaf spring 2910 may comprise a leg 2924 (e.g., a folded leg) and a leaf 2925. The leg may be used to support the leaf spring 2910 over an underlying substrate (e.g., a PCB). The leaf 2925 may be configured to push the plug upward if the plug is installed in to the receptacle 2902. FIG. 29B shows a top view of a plug assembly 2906 and receptacle 2902 in an engaged position. The leaf spring 2910 may be attached to the receptacle 2902. The leaf spring 2910 may be used to apply a clamping force on the plug assembly 2906 in an inserted position. Engagement of the leaf spring 2910 may require pushing the plug assembly 2906 horizontally forward in the receptacle 2902. For example, pushing the plug assembly 2906 horizontally forward in the receptacle may enable the leaf spring to apply a force to the plug assembly 2906 in the direction of the PIC 102 such that the plug assembly 2906 (and the plug 108 (not shown)) and the PIC 102 are aligned (e.g., via the fine alignment features described herein). Further, the clamping force may cause, facilitate, and/or maintain engagement of fine alignment features (e.g., spheres and v-grooves described herein). Disconnecting the plug assembly from the receptacle 2902 may require pulling the leaf spring 2910 back to reduce pressure (and/or force) on the plug assembly 2906. The reduction in pressure (and/or force) may allow the plug to drop down from its installed position (e.g., to move away from the PIC 102) and move back (e.g., be moved horizontally).

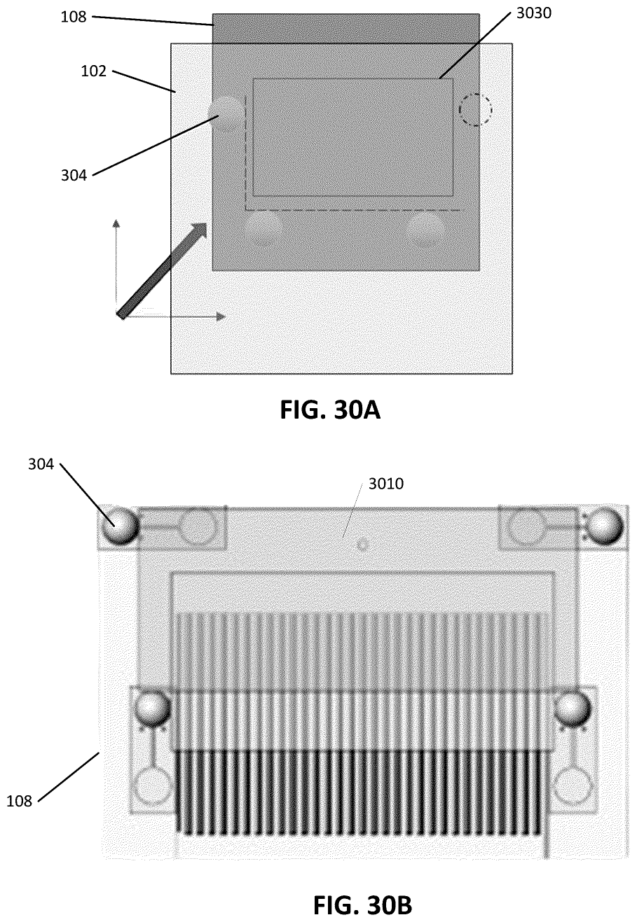

FIGS. 30A-30B depict example self-aligning mechanics according to one or more aspects of the present disclosure. FIG. 30A shows a front view of a plug 108 and PIC 102 mating. FIG. 30B shows a back view of an example plug 108 and PIC mating. The plug 108 may have spheres 304. The spheres 304 may be arranged such that a substantially right-angle corner is defined, for example, as shown in FIG. 30A. All DOF may be defined by three spheres 304. In such a configuration, the Z, Θ, φ coordinates may be defined by pressing the spheres against the PIC 102 (e.g., v-grooves in the PIC 102). The X, Y and W coordinates may be defined by sliding the plug 108 in plane against the BoC corner 3030. The glass 3010 may be used to slide the plug into place by guiding the glass 3010 onto the BoC corner 3030. In such a configuration, the BoC thickness may be configured to a thickness of at least half the diameter of the spheres 304. The Z clamping force may be located within the triangle defined by the spheres 304. Additionally or alternatively, a fourth (or more) sphere 304 may be added. In such a case, one of the spheres 304 may be elevated off the PIC.

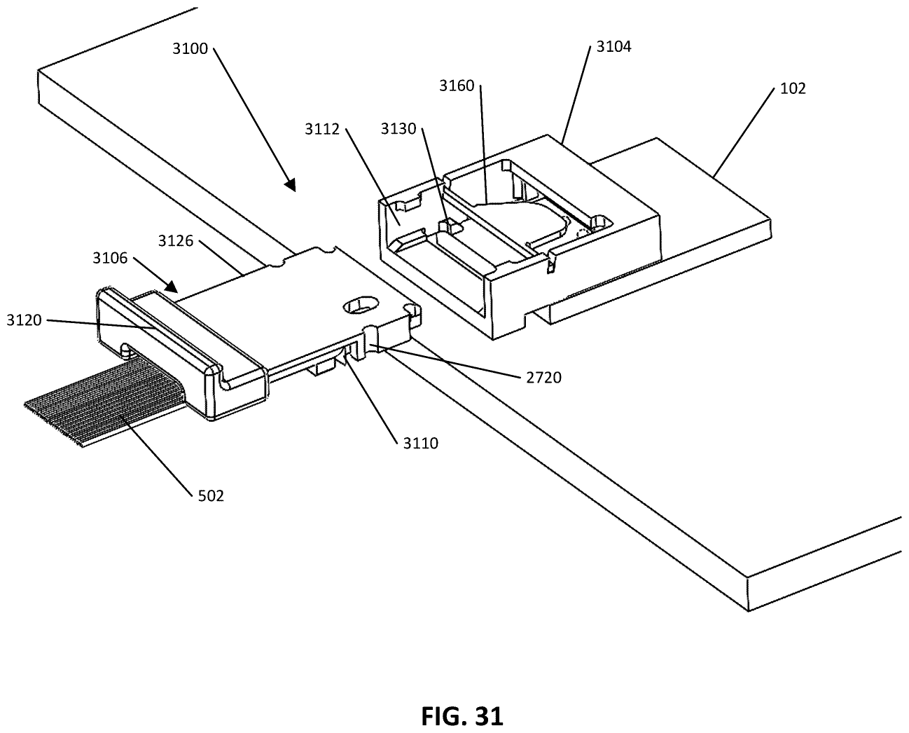

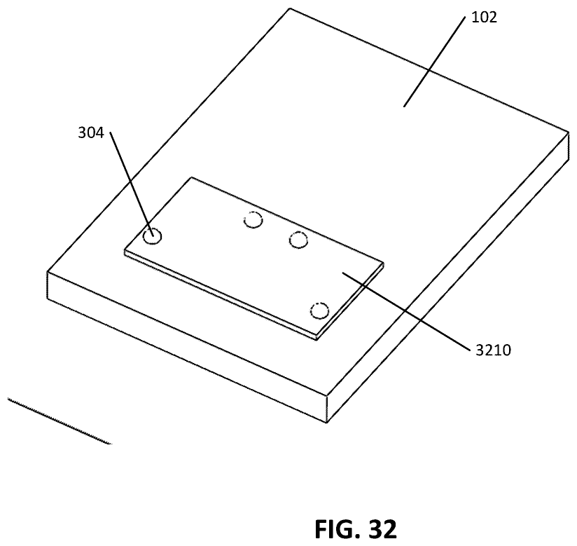

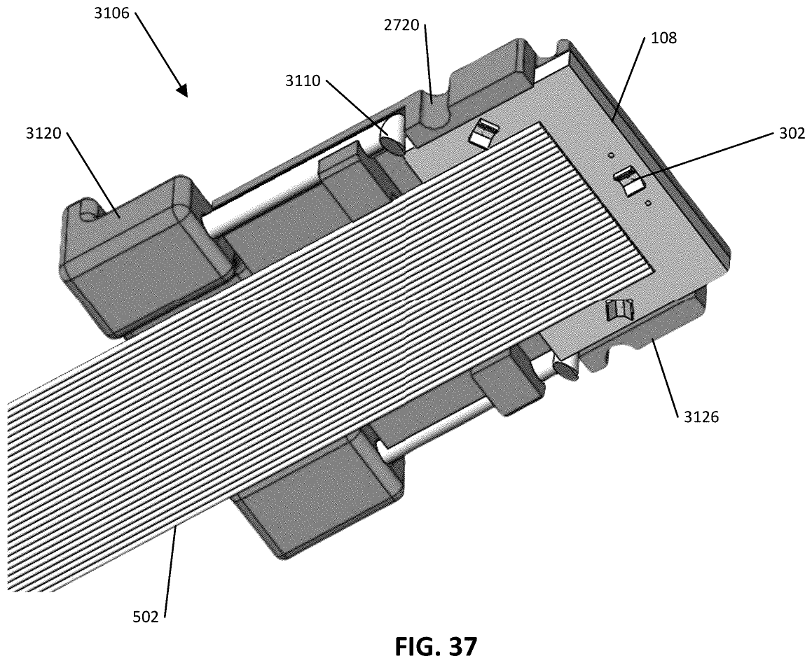

FIG. 31 depicts an example detachable connector 3100 according to one or more aspects of the present disclosure. The detachable connector 3100 may comprise a plug assembly 3106 and a receptacle 3104 (which together, may be a part of a detachable connector system). The plug assembly 3106 may comprise a plug cover 3126 (e.g., similar to plug cover 526 unless otherwise described). The plug cover 3126 may house a photonic plug (substantially as described herein (e.g., with respect to FIGS. 5A-5B, 14A-14B, and 16) (e.g., as shown in FIG. 36 and FIG. 37). The photonic plug (show in FIG. 36) may be attached to fiber ribbon 502. The plug cover 3126 may comprise cutouts 2720. The plug assembly 3106 may comprise an extraction mechanism (e.g., extraction system) comprising plug separation surface 3110, and movable grip 3120. The plug separation surface 3110 may be disposed on an end of one or more extensions extending from the moveable grip 3120.

The detachable connector 3100 (e.g., the system) may further comprise a receptacle 3104. The receptacle 3104 may comprise guiding rail 3112 to assist (e.g., coarse align) the plug assembly 3106 during insertion. The receptacle 3104 may further comprise a receptacle separation surface 3130. The receptacle separation surface 3130 may work in tandem with the plug separation surface 3110 to assist the plug separation surface 3110 in detaching and removing the plug assembly 3106 from the receptacle 3104 (as described in more detail herein). The receptacle 3104 may further comprise a spring 3160, for example, as a retaining mechanism, to push and hold the plug assembly 3106 in the direction of the PIC 102 and to maintain engagement of fine alignment features, between the photonic plug (not shown) and the PIC 102, as described in more detail herein. The receptacle 3104 may be coupled to the PIC 102 and/or the underlying substrate. The plug assembly 3106 may be inserted (e.g., horizontally) into receptacle 3104. The shape of the plug cover 3126 and the corresponding guiding rails 3112, may be configured as a coarse alignment features. For example, the plug cover 3126 may be shaped (e.g., comprising a thickness) that mechanically fits into the guiding rails 3112 such that the photonic plug is coarsely aligned with the PIC 102. If the plug assembly 3106 is inserted into the receptacle 3104, the cutouts 2720 may be mated with cylinders (not shown) inside the receptacle 3104. The movable grip 3120 may be movable (e.g., slidable) and may be coupled to the plug separation surface 3110 to move the plug separation surface 3110 to assist insertion and removal of plug assembly 3106 (as described in more detail herein). The plug separation surface 3110 may be positioned about a center of mass.

FIG. 32 depicts a micro aligner 3210 on the PIC 102 according to one or more aspects of the present disclosure. Micro aligner 3210 may be coupled to PIC 102. The micro aligner 3210 may further comprise spheres 304 that be mated with v-grooves of the photonic plug for fine alignment. The micro aligner 3210 may be an example of a BoC, such as BoC 2018 as discussed above with reference to FIG. 20. Also or alternatively, the micro aligner 3210 may or may not include optical features (e.g., mirrors, lenses, etc.), depending on configuration. For example, in some configuration, the photonic plug may be optically coupled to existing optical features on the PIC 102 (e.g., a lensed mirror of the PIC 102) without the assistance of additional optical components (e.g., from a BoC). In such configurations, the micro aligner 3120 may simply comprise mechanical micro alignment features (e.g., spheres 304, v-grooves, etc.) to align the photonic plug with the existing optical features of the PIC 102. The micro aligner 3210 may be positioned over the PIC 102 using pick and place machinery. The micro aligner 3210 may be bonded to the PIC 102 once positioned. The micro aligner 3210 may also comprise fine alignment features such as spheres 304.

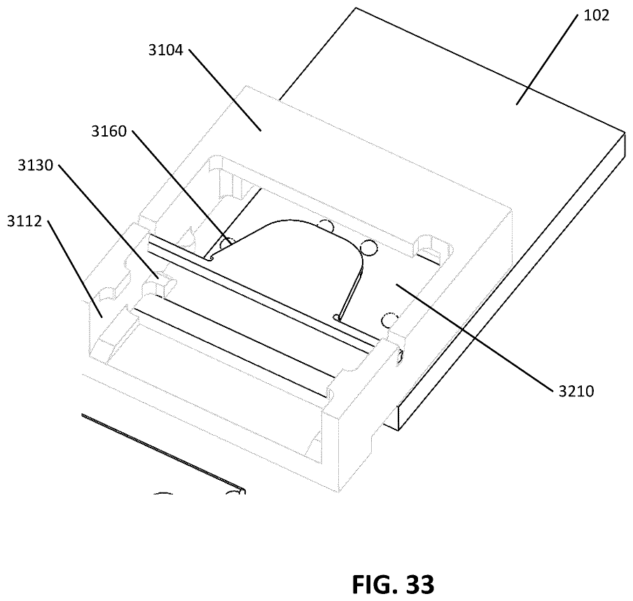

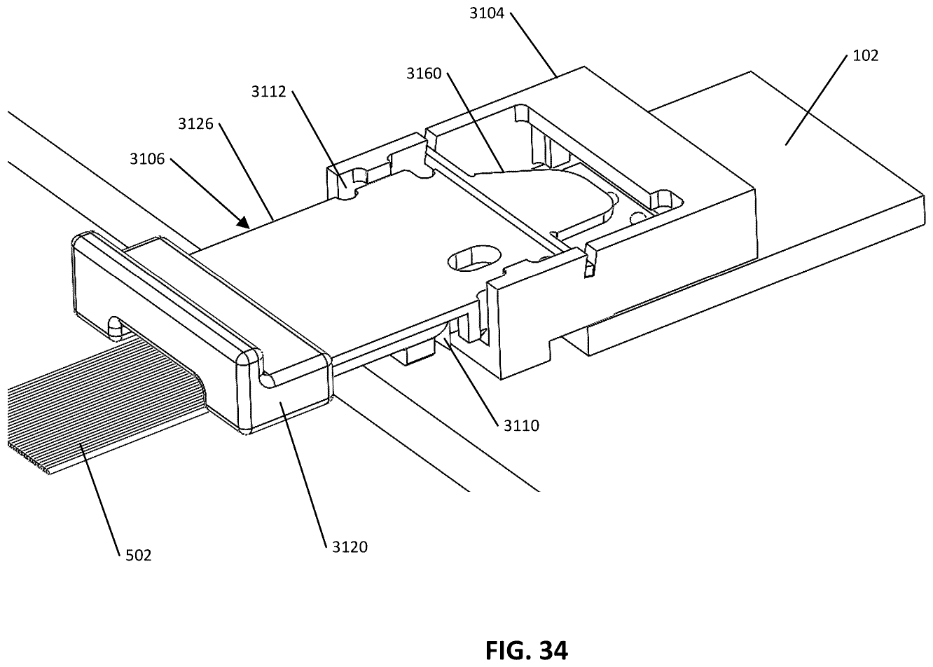

FIG. 33 depicts a receptacle 3104 on top of a PIC 102 and micro aligner 3210 according to one or more aspects of the present disclosure. FIG. 33 shows receptacle 3104 coupled to one or more of the micro aligner 3210 and PIC 102. The receptacle 3104 may comprise a guiding rail 3012 and receptacle separation surface 3130 (as further described herein). The receptacle 3104 may be positioned and aligned over the PIC 102 using pick and place machinery. The receptacle 3104 may be bonded to one or more of the PIC 102, the micro aligner 3210 and/or an underlying substrate (e.g., PCB) following positioning and placement. The receptacle 3104 and micro aligner 3210 may be designed to withstand any reflow process the PIC 102 and/or underlying package may undergo.

FIG. 34 depicts a plug assembly 3106 and receptacle 3104 in a sliding position according to one or more aspects of the present disclosure. The plug assembly 3106 may be inserted into the guiding rail 3112 for coarse horizontal placement. Accordingly, the shape of the plug cover 3126 and the corresponding guiding rail 3112, may together be configured as horizontal coarse alignment features. Separation surface 3110 may assist the plug assembly 3106 into a secure position, as described in more detail herein. Following insertion (e.g., horizontally) of the plug assembly 3106, a vertical movement (e.g., a drop) may further secure a mated position between the plug assembly 3106 and the receptacle 3104. The mating process may comprise features such as those discussed herein.

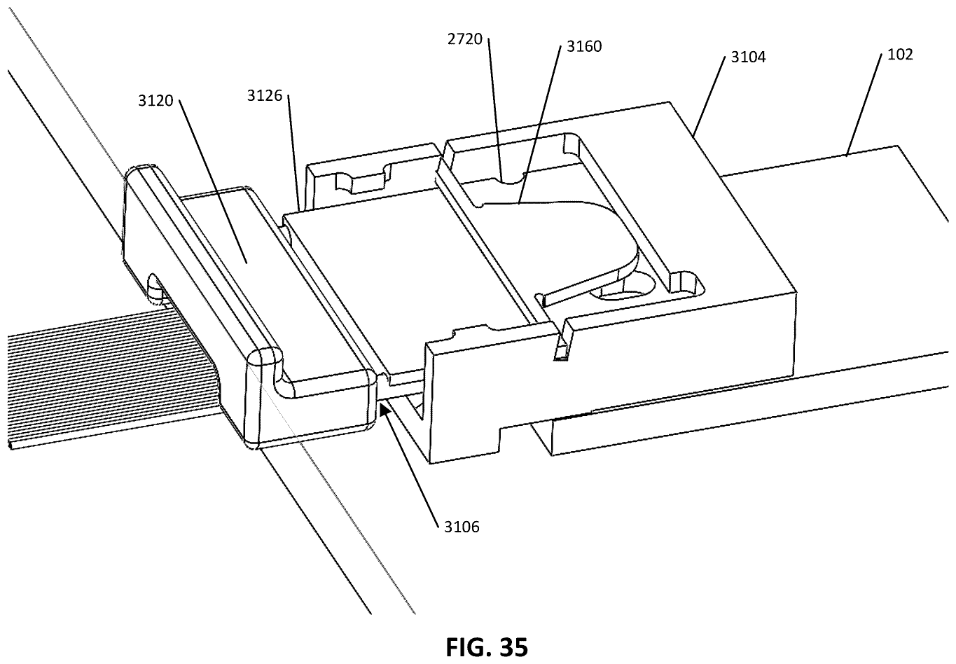

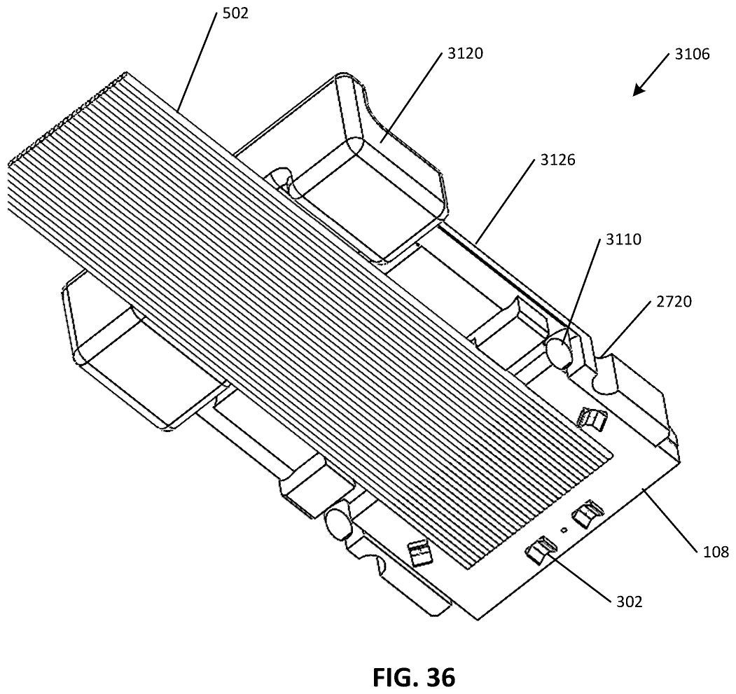

FIG. 35 depicts a plug and socket in a mated position according to one or more aspects of the present disclosure. Plug assembly 3126 may be mated with receptacle 3104 using fine alignment and rough alignment features as discussed herein. With reference to FIG. 35, as the plug assembly is inserted into the receptacle 3104, the plug assembly 3106 may apply a force to the spring 3160 deflecting the spring (e.g., upward) from its resting position. Accordingly, as the plug assembly 3106 is inserted into the receptacle 3104, the spring may, in turn, provide a force to the plug assembly 3106, for example, in the direction towards the PIC 102. The guiding rail 3112 and a portion of the plug assembly 3106 (e.g., the plug cover 3126) may be configured such that the plug assembly 3106 remains lifted a distance (e.g., spaced) from the PIC 102 while being inserted into the receptacle (e.g., resisting substantial vertical movement of the plug assembly 3106 in relation to the PIC 102 and/or receptacle 3104). Further, the receptacle 3104 and plug assembly 3106 may be configured to allow vertical movement of the plug assembly 3106 following substantially complete horizontal insertion of the plug assembly 3106 into the receptacle 3104. Additionally, the cutouts 2720 may be mated to cylinders/bars (not shown) within the receptacle 3104 for additional coarse alignment.

FIG. 36 and FIG. 37 depict bottom views of an example plug assembly 3106 according to one or more aspects of the present disclosure. Plug assembly 3106 may comprise, house, and/or be connected to photonic plug 108. Optical fibers, for example, fiber ribbon 502 may be connected to the photonic plug 108. Optical fibers of fiber ribbon 502 may be bonded to the photonic plug 108 to provide strain relief. Similar to that which is described elsewhere herein, the photonic plug 108 may comprise fine alignment features. In the examples of FIG. 36 and FIG. 37, the photonic plug comprises v-groove 302 fine alignment features. As described herein, the v-grooves 302 may be mated with corresponding mechanical fine alignment features (e.g., on a PIC, on a BoC, on a micro aligner) (e.g., spheres or semi-spheres) to finely align the photonic plug, and the connected optical fibers, with the PIC, for example, to facilitate optical connection (e.g., coupling) of the optical fibers to the PIC (e.g., a transceiver of the PIC). Different configurations may comprise different numbers of fine alignment features, for example, v-grooves 302. For example, the example photonic plug 108 of FIG. 36 comprises four v-grooves 302 for fine alignment while the example of FIG. 37 comprises three. Other examples may include different numbers and configurations of fine alignment features.

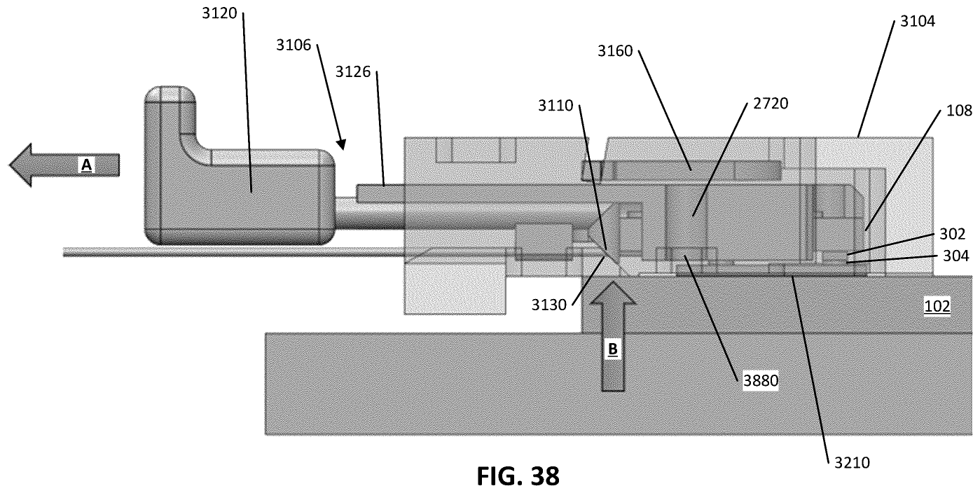

FIG. 38 depicts an example of a detachable plug assembly 3106 in a receptacle 3104 according to one or more aspects of the present disclosure. Although, FIG. 38 depicts arrows for plug assembly 3106 extraction, plug assembly 3106 installation is first described. With continued insertion of the plug assembly 3106 into the receptacle 3104, the plug assembly 3106 (e.g., coarse alignment features thereof) may clear the guide rail 3112 and the receptacle separation and may be enabled to move vertically (e.g., toward the PIC 102). Accordingly, the force of the spring 3160 on the plug assembly 3106 (e.g., in the horizontal (e.g., downward) direction) may move the plug vertically (e.g., downward), for example, in the direction of the PIC 102. As the plug assembly moves vertically, the cutouts 2720 may engage and be mated with the cylinders 3880. The engagement of the cutouts 2720 and the cylinders 3880 may provide multiple advantages, including: assisting in coarse alignment of the plug assembly 3160 (and the photonic plug 108), and resisting the horizontal movement of the plug assembly 3160 in relation to the receptacle 3104 and the PIC 102. With continued vertical movement (e.g., toward the PIC 102) of the plug assembly 3106 (e.g., as assisted by the spring 3160), the fine alignment features of the photonic plug 108 may engage the fine alignment features of the PIC 102 (and/or a BoC or micro aligner 3210). For example, with continued vertical movement of the plug assembly 3106 toward the PIC 102, the v-grooves 302 of the photonic plug 108 may engage the spheres 304 of the micro aligner 3210 such that the optical components (e.g., optical fibers) connected to the photonic plug 108 may be finely aligned, in this installed position, with optical elements of the PIC 102 (e.g., transceiver, lensed mirror, grating coupler, laser) enabling optical communication between the optical components attached to the photonic plug 108 and the PIC 102. The force from the spring 3160 on the plug assembly 3106 may maintain the plug assembly 3106 in the above described installed position and may maintain the engagement of the rough and fine alignment features.

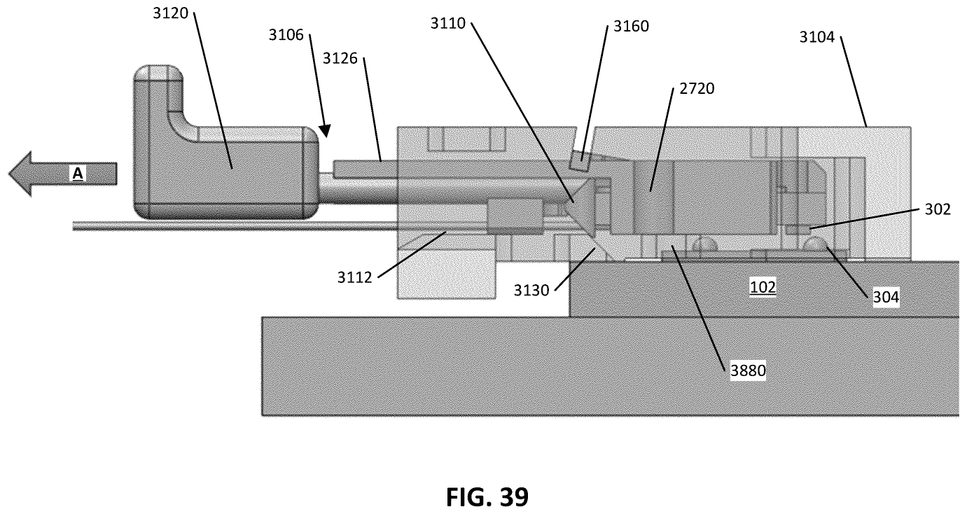

Following installation, it may be desirable to disconnect (e.g., extract, uninstall, etc.) the plug assembly 3106 from the PIC 102 and the receptacle 3104 (e.g., for service). The extraction features may not be described with continued reference to FIG. 38 and with reference to FIG. 39. It may be appreciated that simply pulling horizontally on the installed plug assembly 3106 may increase the chances of damaging one or more features (e.g., the fine alignment features, the mating surfaces, etc.) Accordingly, FIGS. 38 and 39 show features and a method for removing (e.g., extracting) the plug assembly 3106 from the receptacle with reduced chance of such damage. In a first extraction step, the movable grip 3120 may be pulled (as shown by arrow A) to initiate a vertical movement (e.g., upward) (e.g., away from the PIC) of the plug assembly 3106 for ejection. Moving the moveable grip 3120, as described, may move the, connected, plug separation surface 3130 in the direction of, and cause engagement with, the corresponding receptacle separation surface 3130. The plug separation surface 3110 and the receptacle separation surface 3130 may be correspondingly configured such that a force on the surfaces in a horizontal direction, translates to a force on the plug assembly 3106 and receptacle 3104 in the vertical direction (e.g., a force that vertically separates the plug assembly 3106 and receptacle 3104. Thus, initial horizontal movement of the moveable grip may cause vertical movement of the plug assembly 3126.

FIG. 39 depicts a detachable plug during extraction according to one or more aspects of the present disclosure. Referring to FIG. 39, with continued horizontal force and motion to the moveable grip 3120, the plug extraction surface 3110 and the receptacle extraction surface 3130 may continue to engage and exert a vertical force on the plug assembly 3106. Further, the horizontal force on the moveable grip 3120 may exert a horizontal force on the remainder of the plug assembly 3106. With these forces, the engagement of the plug extraction surface 3110 and the receptacle extraction surface 3130, may act as a ramp to move the plug assembly vertically, pushing the spring 3160, lifting the plug assembly 3106, and causing vertical disengagement of the fine alignment features (e.g., v-grooves 302 and spheres 304) and the cutout 2720 and cylinder 3880. With the vertical disengagement of the fine alignment features, the plug assembly 3016 may be horizontally removed from the receptacle 3104 (e.g., in a substantially reverse method to the installation described above). In this way (e.g., vertical movement and then horizontal movement), the chances of damaging the fine alignment features and mating faces of the photonic plug 108 and PIC 102 may be reduced. In some configurations, all features described herein as features of a plug assembly (e.g., plug assembly 3016) and or a plug cover (e.g., plug cover 3126) may be incorporated into a photonic plug 108.

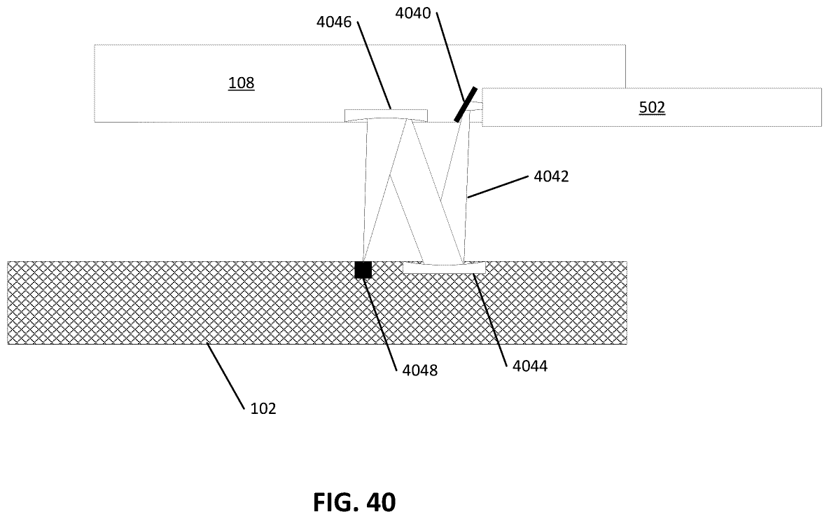

FIG. 40 shows an example optical scheme for which the detachable connectors of the present disclosure may be used. For example, the optical scheme may include a photonic plug 108 connected to one or more optical fibers (e.g., fiber ribbon 502). The photonic plug may further comprise a first mirror 4040. The first mirror may comprise a substantially flat mirror, for example, a tilted substantially flat mirror, to direct the light beam 4042 into and out of the optical fiber. The light beam 4042 may be coupled to a first curved mirror 4044. The examples of BoC's described herein (e.g., BoC 2018) may comprise a mirror substantially similar to first curved mirror 4044. The first curved mirror may focus the light beam 4042 in the direction of the first mirror 4040, and/or may collimate the light beam 4042 in the direction of the second curved mirror 4046 (e.g., photonic plug curved mirror 4046). The second curved mirror 4046 may interface with the light beam 4042 and may focus the light beam in the direction of the PIC transceiver 4048 (e.g., mirror, grating coupler, waveguide, laser, etc.) and/or may collimate the light beam in the direction of the first curved mirror 4044. The methods, systems, and apparatuses described herein above may be used to detachably couple the photonic plug of FIG. 40 from the PIC 102 as described.

Other optical schemes may be used as well. For example, some example configurations may omit the first curved mirror 4044 and/or the second curved mirror 4046. The first mirror 4040 may comprise a focusing mirror configured to either collimate or focus a light beam. Further, the first mirror 4040 may interface the light beam directly with the PIC transceiver 4048, for example, instead of interfacing the light beam 4042 with the first curved mirror 4044. Thus, the present detachable connectors described herein may also be used, for example, to couple to collimated beams directly between the first mirror 4040 and the PIC and/or focusing beams directly between the first mirror 4040 and the PIC (e.g., a PIC comprising a lensed mirror at the transceiver 4048). The above described optical schemes are not intended to limit the scope of the present disclosure but merely to provide examples to illustrate some of the optical schemes with which the present detachable connectors may be used.

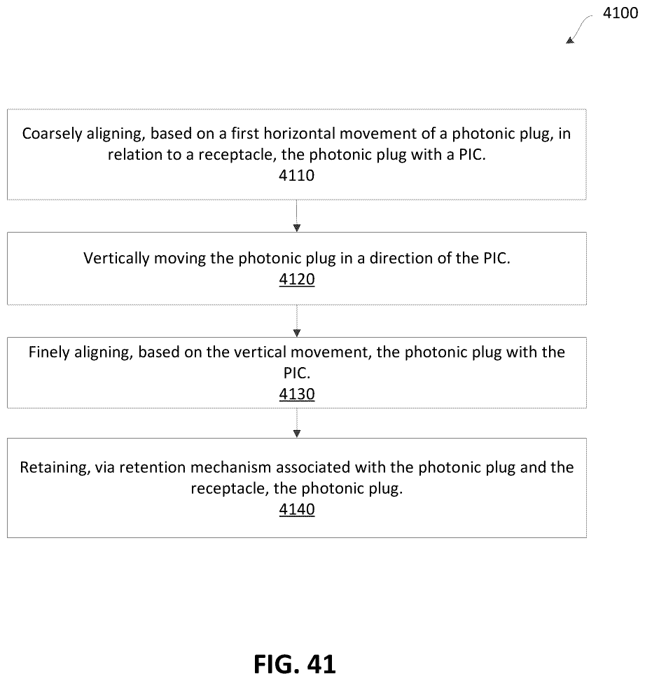

FIG. 41 shows an exemplary method for effecting a detachable optical connection between one or more optical fibers and PIC according to one or more aspects of the present disclosure. FIG. 41 shows an example method 4100 for effecting a detachable optical connection between one or more optical fibers and PIC. At step 4110, method 4100 may comprise coarsely aligning, based on a first horizontal movement of a photonic plug, in relation to a receptacle, the photonic plug with a PIC. The PIC may comprise an optical transceiver. At step 4120, method 4100 may further comprise vertically moving the photonic plug in a direction of the PIC. At step 4130, method 4100 may further comprise finely aligning, based on the vertical movement, the photonic plug with the PIC. The finely aligning may cause engagement of first fine alignment features, of the photonic plug, with second corresponding fine alignment features associated with the PIC. The finely aligning the photonic plug with the PIC may comprise aligning and substantially restraining the photonic plug in relation to the PIC in one or more of a Z-axis, a pitch-axis, and a roll-axis. The finely aligning the photonic plug with the PIC may comprise aligning and substantially restraining the photonic plug in relation to the PIC in or more of an X-axis, a Y-axis, and a, yaw-axis. At step 4140, method 4100 may further comprise retaining, via retention mechanism associated with the photonic plug and the receptacle, the photonic plug. The retention mechanism may apply a force to the photonic plug in the direction of the PIC.

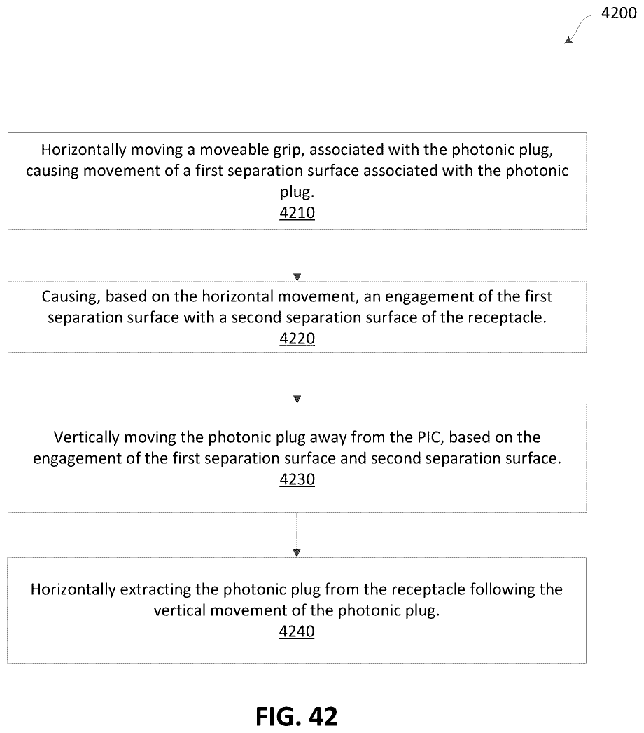

FIG. 42 shows an exemplary method for disconnecting a detachable photonic plug from a receptacle and PIC according to one or more aspects of the present disclosure. FIG. 42 shows an example method 4200 for disconnecting a detachable photonic plug from a receptacle and PIC. At step 4210, method 4200 may comprise horizontally moving a moveable grip, associated with the photonic plug, causing movement of a first separation surface associated with the photonic plug. At step 4220, method 4200 may further comprise causing, based on the horizontal movement, an engagement of the first separation surface with a second separation surface of the receptacle. The first separation surface and the second separation surface may comprise complimentarily configured slanted surfaces such that, a force in horizontal direction between the two surfaces may translate to a force in the vertical direction between the two surfaces. At step 4230, method 4200 may further comprise vertically moving the photonic plug away from the PIC, based on the engagement of the first separation surface and second separation surface. The vertical movement of the photonic plug may cause disengagement of first fine alignment features of the photonic plug from second fine alignment features associated with the PIC. The vertical movement of the photonic plug may comprise disengagement of one or more rough alignment features between the photonic plug and the receptacle. At step 4240, method 4100 may further comprise horizontally extracting the photonic plug from the receptacle following the vertical movement of the photonic plug. The horizontal extraction may comprise guiding the photonic plug in a horizontal direction in relation to the receptacle via one or more first coarse alignment features of the photonic plug and one or more corresponding second coarse alignment features of the receptacle.

A system may comprise a photonic integrated circuit (PIC) associated with one or more first fine alignment features. The system may comprise a photonic plug configured to be attached to one or more optical fibers. The photonic plug may comprise one or more plug coarse alignment features. The photonic plug may comprise one or more second fine alignment features configured to engage the one or more first fine alignment feature finely aligning the one or more optical fibers with the PIC. The system may comprise a receptacle configured to receive the plug and to engage the one or more plug coarse alignment features, coarsely aligning the one or more optical fibers and the PIC. The system may comprise a retention mechanism configured to substantially retain the photonic plug in the receptacle in relation to the PIC. The PIC may comprise one or more transceivers. The PIC may comprise one or more optical terminus components. The engagement of the one or more first fine alignment features and the one or more second fine alignment features may maintain alignment of the PIC and the one or more optical fibers such that the one or more transceivers may optically couple to the one or more optical fibers. The one or more first fine alignment features may be fabricated on a surface of the PIC. The system may comprise a carrier substrate connected to the PIC, wherein the carrier substrate comprising the first fine alignment features. The carrier substrate may comprise a photonic bump, wherein the photonic bump may comprise an optical focusing element. The optical focusing element may facilitate optical connection of the one or more optical fibers and the PIC. The one or more first fine alignment features may comprise spheres or semi-spheres. The one or more first fine alignment features may comprise one or more trenches. The one or more trenches may comprise one or more v-grooves. The one or more second fine alignment features may comprise spheres or semi-spheres. The one or more second fine alignment features may comprise trenches. The one or more trenches may comprise v-grooves. The one or more first fine alignment features and the one or more second fine alignment features may mechanically correspondingly engage each other and effectuate the fine alignment of the PIC and the one or more optical fibers. Each of the one or more first fine alignment features may correspond to a second fine alignment feature of the one or more second fine alignment features. The system may comprise three each of the first and second fine alignment features. The system may comprise four of each of the first and second fine alignment features. The system may comprise three of each of the first and second fine alignment features, the first and second fine alignment features may be arranged on the PIC and the photonic plug in an isosceles triangle arrangement. The system may comprise three of each of the first and second fine alignment features, the first and second fine alignment features may be arranged on the PIC and the photonic plug in a right triangle arrangement. The fine alignment features may maintain alignment between the PIC and the photonic plug in one or more of a Z-axis, a pitch-axis, and a roll-axis. The one or more coarse alignment features may maintain alignment between the PIC and photonic plug in one or more of an X-axis, Y-axis, and yaw-axis. The photonic plug and the receptacle may first coarsely align the photonic plug and the PIC based on one or more of the one or more plug coarse alignment features and based on a horizontal insertion of the photonic plug into a socket of the receptacle, and may second coarsely align the photonic plug and the PIC based on one or more other coarse plug coarse alignment features and a vertical movement of the plug in relation to the PIC. The receptacle may comprise comprises one or more receptacle coarse alignment features. The one or more plug coarse alignment features may engage the one or more receptacle coarse alignment features, and may coarsely align the one or more optical fibers and the PIC. The photonic plug and the receptacle may coarsely align the photonic plug and the PIC based on a vertical movement of the photonic plug relative to the PIC and follow the horizontal insertion. The retention mechanism may comprise a spring. The spring may connect to the photonic plug and the spring may assert a force on the photonic plug to drawing the photonic plug in a direction of the PIC. The spring may comprise a leaf spring. The leaf spring may be attached to the receptacle and may assert a force on the photonic plug in a direction of the PIC to maintain engagement of the first one or more fine alignment features and the second one or more fine alignment features. The leaf spring may be connected to a lever, wherein, moving the lever may cause the leaf spring to deform and at least partially relieve the force asserted on the photonic plug. The retention mechanism may comprise one or more magnets. The one or more magnets may comprise a first magnet associated with the photonic plug and a second magnet of the receptacle, the first and second magnets may draw or repel the photonic plug in a direction of the PIC. The retention mechanism may comprise a wire spring associated with the photonic plug. The receptacle may comprise an inclined surface such that, insertion of the photonic plug into the receptacle may cause engagement of the wire spring and the inclined surface, and may draw the photonic plug in a direction of the PIC. The inclined surface may connect to a lever arm. The level arm may receive a force and deflect the inclined surface and release the retained photonic plug. The one or more plug coarse alignment features may comprise ball bearings. The one or more plug coarse alignment features may comprise bonded ball bearings, bonded to a surface of the photonic plug. The receptacle may comprise vertical rails and horizontal rails configured to receive the bonded ball bearing and guide the bonded ball bearing, vertically and horizontally, in the receptacle. The one or more plug coarse alignment features may comprise one or more cylindrical protrusions. The one or more plug coarse alignment features may comprise bars. The receptacle may engage the bars in holes mechanically complimentarily configured to the bars. The one or more plug coarse alignment features may comprise holes. The receptacle may engage the holes via bars, mechanically complimentarily configured to the holes. The plug coarse alignment features may comprise a shape of the photonic plug, and the receptacle may receive the shape of the photonic plug and coarsely align the photonic plug with the PIC based on receiving the shape of the photonic plug. The one or more plug coarse alignment features may comprise a cutout. The receptacle may comprise snap arms configured such that insertion of the photonic plug into the receptacle, may cause the snap arms to deform and snap into the cutout. The retention mechanism may comprise cutouts in the photonic plug, and the receptacle may comprise snap arm configured such that insertion of the photonic plug into the receptacle may cause the snap arms to deform and snap into the cutout. The receptacle may comprise a cylinder that may engage the cutout based on a vertical movement of the photonic plug in a direction of the PIC. The photonic plug may comprise a photonic plug assembly connected to the photonic plug. The features of the photonic plug may comprise features of the photonic plug assembly. The photonic plug assembly may comprise a photonic plug cover. The photonic plug may be housed in and may connect to the photonic plug assembly. The photonic plug may align with the photonic plug assembly via fine alignment features comprising, v-grooves and mechanically corresponding spheres. The photonic plug assembly may comprise a moveable grip connected to a separation surface. A movement of the moveable grip may engage the separation surface with a corresponding surface of the receptacle such that the photonic plug assembly may move vertically away from the PIC. The photonic plug assembly may comprise a movable grip connected to a separation surface. A horizontal movement of the moveable grip may translate, via the separation surface, to a vertical force on the photonic plug assembly causing vertical separation of the photonic plug and the PIC. The photonic plug assembly may comprise a movable grip connected to a separation surface. A horizontal movement of the moveable grip may translate, via the separation surface, to a vertical force on the photonic plug assembly causing vertical separation of the photonic plug and the PIC and may disengage the one or more first and second fine alignment features. An apparatus may comprise the photonic plug. An apparatus may comprise the receptacle.

A method may comprise multiple operations. The method may effect a detachable optical connection between one or more optical fibers and a photonic integrate circuit (PIC) by: coarsely aligning, based on a first horizontal movement of a photonic plug, in relation to a receptacle, the photonic plug with a photonic integrated circuit (PIC), the photonic plug being connected to one or more optical fibers; subsequently vertically moving the photonic plug in a direction of the PIC; finely aligning, based on the vertical movement, the photonic plug with the PIC. The method may retain, via retention mechanism associated with the photonic plug and the receptacle, the photonic plug. The retention mechanism may apply a force to the photonic plug in the direction of the PIC. The finely aligning may cause engagement of first fine alignment features, of the photonic plug, with second corresponding fine alignment features associated with the PIC. The PIC may comprise an optical transceiver. The finely aligning the photonic plug with the PIC may align and substantially restrain the photonic plug in relation to the PIC in one or more of a Z-axis, a pitch-axis, and a roll-axis. The finely aligning the photonic plug with the PIC may align and substantially restrain the photonic plug in relation to the PIC in or more of an X-axis, a Y-axis, and a, yaw-axis.

A method may comprise multiple operations. The method may disconnect a detachable photonic plug from a receptacle and photonic integrated circuit (PIC). The disconnect may horizontally move a moveable grip, associated with the photonic plug, cause movement of a first separation surface associated with the photonic plug; cause, based on the horizontal movement, an engagement of the first separation surface with a second separation surface of the receptacle; and based on the engagement of the first separation surface and second separation surface, vertically move the photonic plug away from the PIC. The method may follow the vertical movement of the photonic plug, horizontally extract the photonic plug from the receptacle. The vertical movement of the photonic plug may disengage first fine alignment features of the photonic plug from second fine alignment features associated with the PIC. The first separation surface and the second separation surface may complimentarily configure slanted surfaces such that, a force in horizontal direction between the two surfaces may translate to a force in the vertical direction between the two surfaces. The vertical movement of the photonic plug may disengage one or more rough alignment features between the photonic plug and the receptacle. The horizontal extraction may guide the photonic plug in a horizontal direction in relation to the receptacle via one or more first coarse alignment features of the photonic plug and one or more corresponding second coarse alignment features of the receptacle.

Features herein have been described with referential terms, for example, “top,” “bottom,” “underside,” “top-side,” “bottom-side,” and similar. Such terms have been used for ease of description and understanding. However, such terms should not be construed as limiting. For example, though the photonic plug 108 may have been described as mating to the underside of the PIC 102 in one configuration, it will be appreciated that the methods, systems, and apparatuses described herein may be similarly configured to mate a photonic plug 108 to the top-side of the PIC 102.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A system comprising:
a photonic integrated circuit (PIC) associated with one or more first fine alignment features;
a photonic plug configured to be attached to one or more optical fibers, comprising:
one or more plug coarse alignment features; and
one or more second fine alignment features configured to engage the one or more first fine alignment feature finely aligning the one or more optical fibers with the PIC;
a receptacle configured to receive the plug and to engage the one or more plug coarse alignment features, coarsely aligning the one or more optical fibers and the PIC; and
a retention mechanism configured to substantially retain the photonic plug in the receptacle in relation to the PIC.

2. The system of claim 1, wherein the PIC further comprises one or more transceivers, and wherein the engagement of the one or more first fine alignment features and the one or more second fine alignment features maintains alignment of the PIC and the one or more optical fibers such that the one or more transceivers are optically coupled to the one or more optical fibers.

3. The system of claim 1, further comprising a carrier substrate connected to the PIC, the carrier substrate comprising the first fine alignment features.

4. The system of claim 3, wherein the carrier substrate further comprises a photonic bump, the photonic bump comprising an optical focusing element.

5. The system of claim 1, wherein the one or more first fine alignment features comprises:
spheres or semi-spheres.

6. The system of claim 1, wherein the one or more second fine alignment features comprise v-grooves.

7. The system of claim 1, wherein the one or more first fine alignment features and the one or more second fine alignment features are mechanically correspondingly configured to engage each other and effectuate the fine alignment of the PIC and the one or more optical fibers.

8. The system of claim 1, further comprising three each of the first and second fine alignment features, the first and second fine alignment features arranged on the PIC and the photonic plug in a substantially isosceles triangle arrangement.

9. The system of claim 1, wherein the fine alignment features maintain alignment, between the PIC and the photonic plug, in one or more of a Z-axis, a pitch-axis, and a roll-axis.

10. The system of claim 1, wherein the retention mechanism comprises a spring, wherein the spring is connected to the receptacle and wherein the spring is configured to assert a force on the photonic plug, moving the photonic plug in a direction of the PIC.

11. The system of claim 1, wherein the photonic plug comprises a moveable grip connected to a separation surface, wherein a movement of the moveable grip engages the separation surface with a corresponding surface of the receptacle such that the photonic plug is moved vertically away from the PIC.

12. A method comprising:
effecting a detachable optical connection between one or more optical fibers and a photonic integrate circuit (PIC) by:
coarsely aligning, based on a first horizontal movement of a photonic plug, in relation to a receptacle, the photonic plug with a photonic integrated circuit (PIC), the photonic plug being connected to one or more optical fibers;
subsequently vertically moving the photonic plug in a direction of the PIC;
finely aligning, based on the vertical movement, the photonic plug with the PIC.

13. The method of claim 12, further comprising:
retaining, via retention mechanism associated with the photonic plug and the receptacle, the photonic plug, wherein the retention mechanism applies a force to the photonic plug in the direction of the PIC.

14. The method of claim 12, wherein the finely aligning further comprises:
causing engagement of first fine alignment features, of the photonic plug, with second corresponding fine alignment features associated with the PIC.

15. The method of claim 12, wherein the finely aligning the photonic plug with the PIC comprises aligning and substantially restraining the photonic plug in relation to the PIC in one or more of a Z-axis, a pitch-axis, and a roll-axis.

16. A method comprising:
disconnecting a detachable photonic plug from a receptacle and photonic integrated circuit (PIC) by:
horizontally moving a moveable grip, associated with the photonic plug, causing movement of a first separation surface associated with the photonic plug;
causing, based on the horizontal movement, an engagement of the first separation surface with a second separation surface of the receptacle; and
based on the engagement of the first separation surface and second separation surface, vertically moving the photonic plug away from the PIC.

17. The method of claim 16, further comprising:
following the vertical movement of the photonic plug, horizontally extracting the photonic plug from the receptacle.

18. The method of claim 16, wherein the vertical movement of the photonic plug causes disengagement of first fine alignment features of the photonic plug from second fine alignment features associated with the PIC.

19. The method of claim 16, wherein the first separation surface and the second separation surface comprise complimentarily configured slanted surfaces such that, a force in horizontal direction between the first separation surface and the second separation surface is translated to a force in the vertical direction between the two surfaces.

20. The method of claim 17, wherein the horizontal extraction further comprises, guiding the photonic plug in a horizontal direction in relation to the receptacle via one or more first coarse alignment features of the photonic plug and one or more corresponding second coarse alignment features of the receptacle.
